(19) United States
(12) Patent Application Publication
(10) Pub. No.: US 2022/0312524 A1
(43) Pub. Date: Sep. 29, 2022

(54) ELECTRONIC DEVICE AND METHOD OF CONTROLLING CONNECTION WITH COMMUNICATION NETWORK BY ELECTRONIC DEVICE

(71) Applicant: Samsung Electronics Co., Ltd., Suwon-si (KR)

(72) Inventor: Janggun BAE, Suwon-si (KR)

(21) Appl. No.: 17/701,197

(22) Filed: Mar. 22, 2022

Related U.S. Application Data
(63) Continuation of application No. PCT/KR2022/003062, filed on Mar. 4, 2022.

(30) Foreign Application Priority Data
Mar. 23, 2021 (KR) 10-2021-0037348

(51) Int. Cl. H04W 76/15; H04W 76/27

(52) U.S. Cl. CPC H04W 76/15; H04W 76/27

(57) ABSTRACT

An electronic device is provided. The electronic device includes an application processor, at least one antenna module, and at least one communication processor configured to receive a communication service from a first communication network and a second communication network through the at least one antenna module, wherein the at least one communication processor is configured to transmit and receive data to and from a second communication processor in an radio resource control (RRC)-connected state with the second communication processor, receive information related to restriction of dual connectivity (DC) with the first communication network from the application processor, set a configuration related to the dual connectivity between the first communication network and the second communication network to be in a disabled state, and control to transmit a message including information corresponding to the configuration to a base station of the second communication network.

### CROSS-REFERENCE TO RELATED APPLICATION(S)

This application is a continuation application, claiming priority under § 365(c), of an International application No. PCT/KR2022/003062, filed on Mar. 4, 2022, which is based on and claims the benefit of a Korean patent application number 10-2021-0037348, filed on Mar. 23, 2021, in the Korean Intellectual Property Office, the disclosure of which is incorporated by reference herein in its entirety.

### TECHNICAL FIELD

The disclosure relates to an electronic device. More particularly, the disclosure relates to a method of controlling a connection with a communication network by the electronic device.

### BACKGROUND ART

As mobile communication technologies are developed, a portable terminal that provides various functions has become popular. Accordingly, an effort to develop a fifth generation (5G) communication system is being made in order to meet wireless data traffic demand which is increasing. In addition to implementation in a frequency band that the third generation (3G) communication system and the long term evolution (LTE) communication system used to use, implementation of the 5G communication system in a higher frequency band (e.g., 25 to 60 GHz band) is being considered in order to provide high data transmission speed for high data transmission rate.

In the 5G communication system, technologies such as beamforming, massive MIMO, full dimensional MIMO (FD-MIMO), an array antenna, analog beamforming, and a large scale antenna are discussed to mitigate a propagation path loss in the mmWave band and to increase a propagation transmission distance.

As a method of implementing 5G communication, a standalone (SA) scheme and a non-standalone (NSA) scheme are being considered. The SA scheme is a scheme that uses only a new radio (NR) system, and the NSA is a scheme that uses the NR system together with the legacy LTE system. In the NSA scheme, a user equipment (UE) may use an eNB in an LTE system, and a gNB in the NR system. A technology in which a UE enables different communication systems is referred to as dual connectivity.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Problem

According to various embodiments, an electronic device supporting dual connectivity (DC) may make dual connectivity with an NR network or a handover to the NR network in a state in which the electronic device is connected to an LTE network. When the electronic device is to be connected to the NR network that is a different type from the LTE network in the LTE network, the electronic device may identify configuration of a B1 event for measurement between radio access technologies (RATs) (inter RAT measurement) for different networks from a base station. The electronic device identifying the configuration information of the B1 event may measure a measurement object (MO) included in the configuration information of the B1 event. When a reporting condition included in the configuration information of the B1 event is satisfied on the basis of the measurement result for the measurement object, a measurement report (MR) for the corresponding measurement object may be transmitted to the base station.

For example, the performance of a procedure for dual connectivity state or dual connectivity may cause an increase in power consumption of the electronic device. When situations in which the electronic device reduces power consumption (for example, a display switches to an off state or a battery has a value equal to or smaller than a configured value) are generated, the electronic device may restrict dual connectivity. In order to restrict the dual connectivity, the electronic device may control not to perform measurement related to the B1 event or control not to report a measurement report (MR) related to the B1 event to the base station.

According to various embodiments, dual connectivity restriction by restriction of an operation related to the B1 event may cause restriction of a handover or redirection to a 5G network by an SA scheme. The connection with the 5G network by the SA scheme may have smaller power consumption than the dual connectivity.

In various embodiments, when the electronic device is in a state related to dual connectivity restriction, an electronic device for enabling a handover or redirection to the 5G network in the state related to dual connectivity restriction and a method of controlling the connection with a communication network by an electronic device may be provided by not restricting dual connectivity by restriction related to the B1 event and changing a configuration related to dual connection restriction.

Aspects of the disclosure are to address at least the above-mentioned problems and/or disadvantages and to provide at least the advantages described below. Accordingly, an aspect of the disclosure is to provide an electronic device and a method for controlling connection with communication network by electronic device.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes an application processor, at least one antenna module, and at least one communication processor configured to receive a communication service from a first communication network and a second communication network through the at least one antenna module, wherein the at least one communication processor is configured to transmit and receive data to and from a second communication processor in an radio resource control (RRC)-connected state with the second communication processor, receive information related to restriction of dual connectivity (DC) with the first communication network from the application processor, set a configuration related to the dual connectivity between the first communication network and the second communication network to be in a disabled state in response to reception of the information related to the restriction of the dual connectivity, and control to transmit a message including information corresponding to the configuration to a base station of the second communication network.

In accordance with another aspect of the disclosure, a method of operating an electronic device is provided. The method includes transmitting and receiving data to and from a second communication processor in an RRC-connected state with the second communication processor, receiving information related to restriction of dual connectivity (DC) with a first communication network from an application processor, setting a configuration related to the dual connectivity between the first communication network and the second communication network to be in a disabled state in response to reception of the information related to the restriction of the dual connectivity, and transmitting a message including information corresponding to the configuration to a base station of the second communication network.

### Advantageous Effects

According to various embodiments, when an electronic device is in a state related to dual connectivity restriction, it is possible to perform a handover or redirection to a 5G network in a state related to dual connectivity restriction by not restricting dual connectivity by restriction related to a B1 event and changing a configuration related to dual connectivity restriction.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device within a network environment according to an embodiment of the disclosure;

FIG. 2A is a block diagram illustrating an electronic device for supporting legacy network communication and fifth generation (5G) network communication according to an embodiment of the disclosure;

FIG. 2B is a block diagram illustrating an electronic device for supporting legacy network communication and 5G network communication according to an embodiment of the disclosure;

FIG. 3A is a diagram illustrating a wireless communication system for providing network of legacy communication and/or 5G communication according to an embodiment of the disclosure;

FIG. 3B is a diagram illustrating a wireless communication system for providing network of legacy communication and/or 5G communication according to an embodiment of the disclosure;

FIG. 3C is a diagram illustrating a wireless communication system for providing network of legacy communication and/or 5G communication according to an embodiment of the disclosure;

FIG. 4 is a block diagram illustrating an electronic device according to an embodiment of the disclosure;

FIG. 5 is a flowchart illustrating an operation in which an electronic device accesses a communication network according to an embodiment of the disclosure;

FIG. 6 is a flowchart illustrating an operation in which an electronic device accesses a communication network according to an embodiment of the disclosure;

FIG. 7 is a flowchart illustrating an operation in which an electronic device accesses a communication network according to an embodiment of the disclosure;

FIG. 8 is a flowchart illustrating an operation in which an electronic device accesses a communication network according to an embodiment of the disclosure;

FIG. 9 is a flowchart illustrating an operation in which an electronic device accesses a communication network according to an embodiment of the disclosure;

FIG. 10 is a flowchart illustrating an operation in which an electronic device accesses a communication network according to an embodiment of the disclosure;

FIG. 11 is a flowchart illustrating an operation in which an electronic device accesses a communication network according to an embodiment of the disclosure;

FIG. 12 is a flowchart illustrating an operation in which an electronic device accesses a communication network according to an embodiment of the disclosure;

FIG. 13 is a flowchart illustrating an operation in which an electronic device accesses a communication network according to an embodiment of the disclosure;

FIG. 14 is a flowchart illustrating an operation in which an electronic device accesses a communication network according to an embodiment of the disclosure;

FIG. 15 is a flowchart illustrating a method by which an electronic device controls a connection with a communication network according to an embodiment of the disclosure;

FIG. 16 is a flowchart illustrating a method by which an electronic device controls a connection with a communication network according to an embodiment of the disclosure; and

FIG. 17 is a flowchart illustrating a method by which an electronic device controls a connection with a communication network according to an embodiment of the disclosure.

Throughout the drawings, like reference numerals will be understood to refer to like parts, components, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

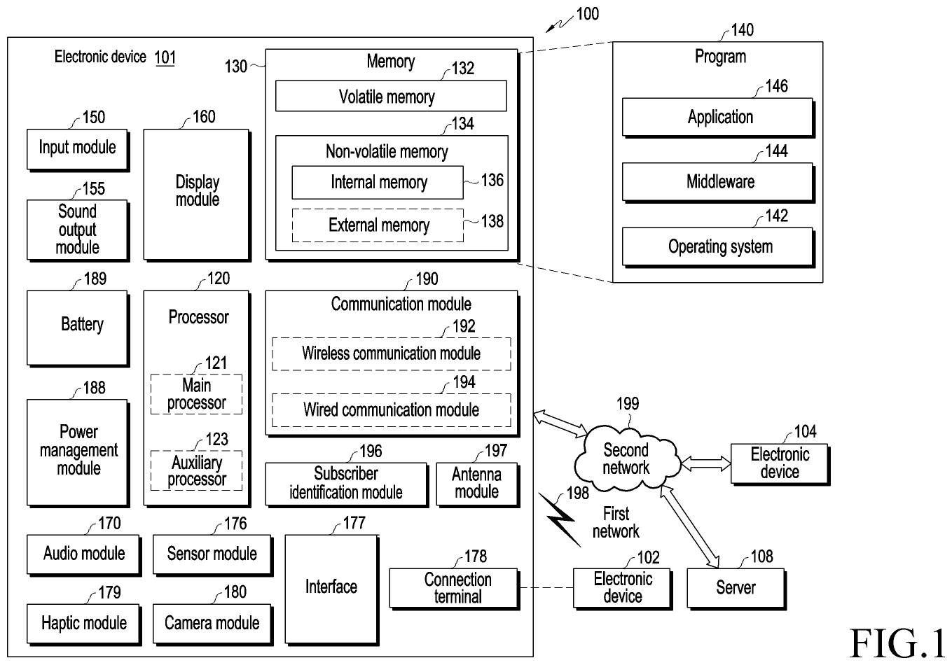

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter (mm) Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

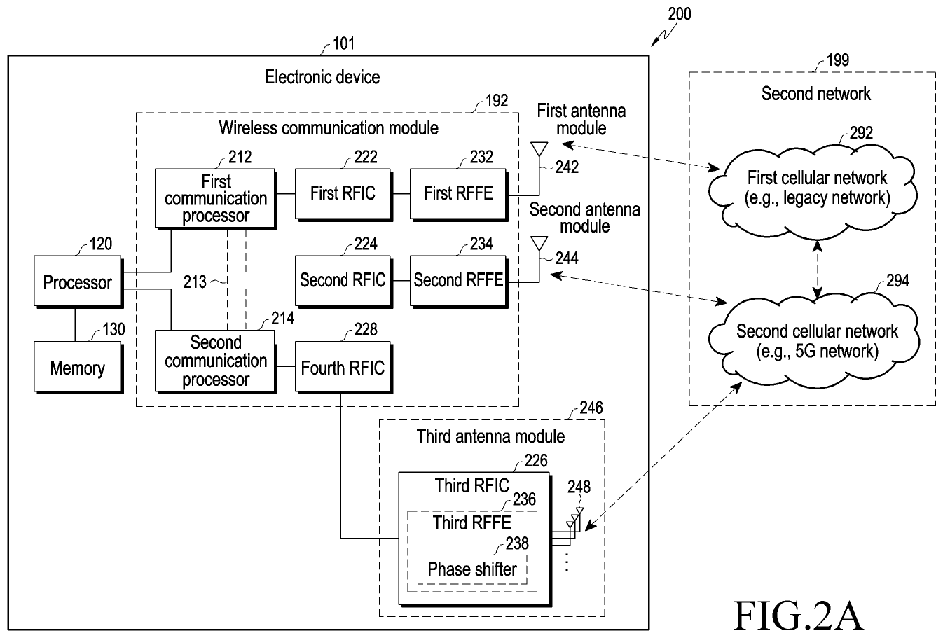

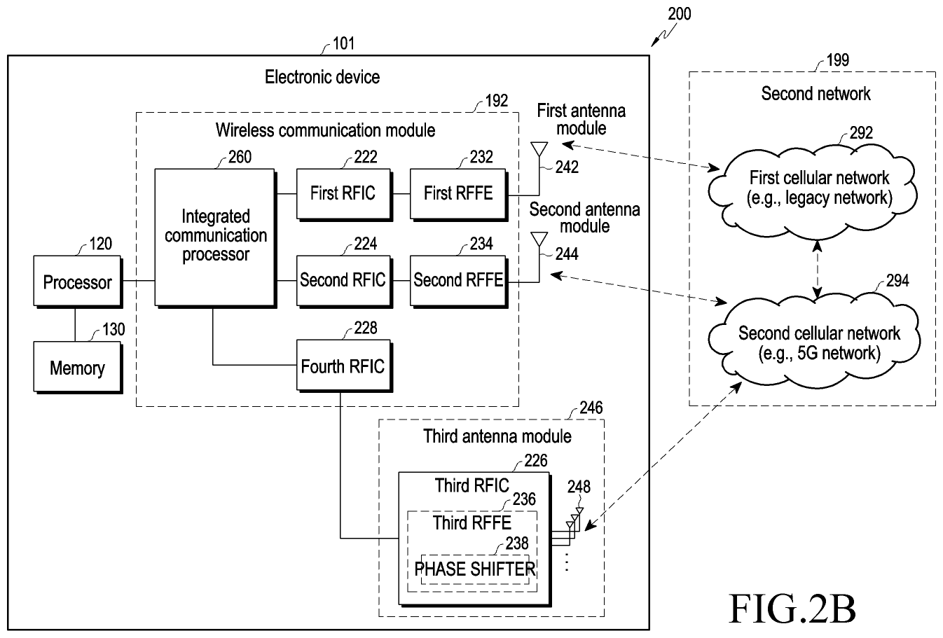

FIG. 2A is a block diagram 200 illustrating the electronic device 101 for supporting legacy network communication and 5G network communication according to an embodiment of the disclosure. FIG. 2B is a block diagram illustrating an electronic device for supporting legacy network communication and 5G network communication according to an embodiment of the disclosure.

Referring to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include the processor 120 and the memory 130. The second network 199 may include a first cellular network 292 and a second cellular network 294. According to another embodiment of the disclosure, the electronic device 101 may further include at least one element among the elements illustrated in FIG. 1, and the second network 199 may further include at least one other network. The first communication processor 212, the second communication processor 214, the first RFIC 222, the second RFIC 224, the fourth RFIC 228, the first RFFE 232, and the second RFFE 234 may be components of the wireless communication module 192. The fourth RFIC 228 may be omitted or may be included as a portion of the third RFIC 226.

The first communication processor 212 may establish a communication channel in a band to be used for wireless communication with the first cellular network 292 and support legacy network communication through the established communication channel. The first cellular network may be a legacy network including a second generation (2G), 3G, 4G, or long term evolution (LTE) network. The second communication processor 214 may support establishment of a communication channel corresponding to a predetermined band (e.g., about 6 GHz to about 60 GHz) among bands to be used for wireless communication with the second network 294 and 5G network communication through the established communication channel. The second cellular network 294 may be a 5G network defined by the 3GPP. In addition, the first communication processor 212 or the second communication processor 214 may establish a communication channel corresponding to another predetermined band (e.g., equal to or lower than about 6 GHz) among bands to be used for wireless communication with the second network 294 and support 5G network communication through the established communication channel.

The first communication processor 212 may transmit and receive data to and from the second communication processor 214. For example, data classified to be transmitted through the second cellular network 294 may be changed to be transmitted through the first cellular network 292. In this case, the first communication processor 212 may receive transmission data from the second communication processor 214. For example, the first communication processor 212 may transmit and receive data to and from the second communication processor 214 through an inter-processor interface 213. The inter-processor interface 213 may be implemented as a universal asynchronous receiver/transmitter (UART) (e.g., a high speed-UART (HS-UART) or a peripheral component interconnect bus express (PCIe) interface), but there is no limitation therein. Alternatively, the first communication processor 212 and the second communication processor 214 may exchange control information and packet data information through, for example, a shared memory. The first communication processor 212 may transmit and receive various pieces of information such as sensing information, information on an output intensity, and resource block (RB) allocation information to and from the second communication processor 214.

The first communication processor 212 may not be directly connected to the second communication processor 214. In this case, the first communication processor 212 may transmit and receive data to and from the second communication processor 214 through the processor 120 (e.g., an application processor). For example, the first communication processor 212 and the second communication processor 214 may transmit and receive data to and from the processor 120 (e.g., an application processor) through an HS-UART interface or a PCIe interface, but there is no limitation on the type thereof. Alternatively, the first communication processor 212 and the second communication processor 214 may exchange control information and packet data information with the processor 120 (for example, an application processor) through a shared memory.

The first communication processor 212 and the second communication processor 214 may be implemented within a single chip or a single package. The first communication processor 212 or the second communication processor 214 may be configured with the processor 120, the auxiliary processor 123, or the communication module 190 within a single chip or a single package. For example, referring to FIG. 2B, the integrated communication processor 260 may support all of functions for communication with the first cellular network 292 and the second cellular network 294.

In transmission, the first RFIC 222 may convert a baseband signal generated by the first communication processor 212 into a radio frequency (RF) signal of about 700 MHz to about 3 GHz used for the first network 292 (e.g., legacy network). In reception, the RF signal may be acquired from the first network 292 (e.g., legacy network) through an antenna (e.g., the first antenna module 242) and may be preprocessed through the RFFE (for example, first RFFE 232). The first RFIC 222 may convert the preprocessed RF signal into a baseband signal which can be processed by the first communication processor 212.

In transmission, the second RFIC 224 may convert a baseband signal generated by the first communication processor 212 or the second communication processor 214 into an RF signal (hereinafter, referred to as a 5G Sub6 RF signal) in a Sub6 band (e.g., equal to or lower than about 6 GHz) used in the second network 294 (e.g., 5G network). In reception, a 5G Sub6 RF signal may be acquired from the second cellular network 294 (e.g., 5G network) through an antenna (e.g., the second antenna module 244) and may be preprocessed through the RFFE (e.g., second RFFE 234). The second RFIC 224 may convert the preprocessed 5G Sub6 RF signal into a baseband signal which can be processed by the corresponding communication processor among the first communication processor 212 or the second communication processor 214.

The third RFIC 226 may convert a baseband signal generated by the second communication processor 214 into an RF signal (hereinafter, referred to as a 5G Above6 RF signal) in a 5G Above6 band (e.g., from about 6 GHz to about 60 GHz) used by the second network 294 (e.g., 5G network). In reception, a 5G Above6 RF signal may be acquired from the second network 294 (e.g., 5G network) through the antenna 248 and may be preprocessed through the third RFFE 236. The third RFIC 226 may convert the preprocessed 5G Above6 RF signal into a baseband signal which can be processed by the second communication processor 214. The third RFFE 236 may be configured as a portion of the third RFIC 226.

The electronic device 101 may include the fourth RFIC 228 separately from the third RFIC 226 or as at least a portion thereof. In this case, after converting a baseband signal generated by the second communication processor 214 into an RF signal (hereinafter, referred to as an IF signal) in an intermediate frequency band (e.g., about 9 GHz to about 11 GHz), the fourth RFIC 228 may transmit the IF signal to the third RFIC 226. The third RFIC 226 may convert the IF signal into a 5G Above6 RF signal. In reception, a 5G Above6 RF signal may be received from the second network 294 (e.g., 5G network) through the antenna 248 and converted into an IF signal by the third RFIC 226. The fourth RFIC 228 may convert the IF signal into a baseband signal which can be processed by the second communication processor 214.

The first RFIC 222 and the second RFIC 224 may be implemented as at least a portion of a single chip or a single package. When the first RFIC 222 and the second RFIC 224 are implemented as a single chip or a single package in FIG. 2A or FIG. 2B, the first RFIC 222 and the second RFIC 224 may be implemented as an integrated RFIC. In this case, the integrated RFIC may be connected to the first RFFE 232 and the second RFFE 234, and may convert a baseband signal into a signal in a band supported by the first RFFE 232 and/or the second RFFE 234 and transmit the converted signal to one of the first RFFE 232 and the second RFFE 234. The first RFFE 232 and the second RFFE 234 may be implemented as at least a portion of a single chip or a single package. At least one of the first antenna module 242 or the second antenna module 244 may be omitted or combined with another antenna module to process RF signals in a plurality of corresponding bands.

According to an embodiment of the disclosure, the third RFIC 226 and the antennas 248 may be arranged on the same substrate to configure the third antenna module 246. For example, the wireless communication module 192 or the processor 120 may be disposed on a first substrate (e.g., main PCB). In this case, the third RFIC 226 may be disposed in a partial area (e.g., bottom side) of a second substrate (e.g., sub PCB) separated from the first substrate and the antennas 248 may be disposed in another partial area (e.g., top side) to configure the third antenna module 246. By placing the third RFIC 226 and the antennas 248 on the same substrate, it is possible to reduce a length of a transmission line therebetween. This is to reduce loss (e.g., attenuation) of the signal in a high frequency band (e.g., about 6 GHz to about 60 GHz) used for 5G network communication due to the transmission line. Accordingly, the electronic device 101 may increase a quality or a speed of communication with the second network 294 (e.g., 5G network).

According to an embodiment of the disclosure, the antennas 248 may be configured as an antenna array including a plurality of antenna elements which can be used for beamforming. In this case, the third RFIC 226 may include a plurality of phase shifters 238 corresponding to the plurality of antenna elements as a portion of the third RFFE 236. In transmission, each of the plurality of phase shifters 238 may convert a phase of a 5G Above6 RF signal to be transmitted to the outside of the electronic device 101 (e.g., a base station of the 5G network) through a corresponding antenna element. In reception, each of the plurality of phase shifters 238 may convert the phase of the 5G Above6 RF signal received from the outside through the corresponding antenna element into the same phase or substantially the same phase. This enables transmission or reception through beamforming between the electronic device 101 and the outside.

The second cellular network 294 may operate independently from the first cellular network 292 (e.g., stand-alone (SA)) or operate through a connection thereto (e.g., non-standalone (NSA)). For example, in the 5G network, only an access network (for example, a 5G radio access network (RAN) or a next generation RAN (NG RAN)) may exist without a core network (e.g., a next generation core (NGC)). In this case, the electronic device 101 may access the access network of the 5G network and then access an external network, such as the Internet, under the control of the core network (e.g., evolved packed core (EPC)) of the legacy network. Protocol information (e.g., LTE protocol information) for communication with the legacy network and protocol information (e.g., new radio (NR) protocol information) for communication with the 5G network may be stored in the memory 230 and may be accessed by another element (e.g., the processor 120, the first communication processor 212, or the second communication processor 214).

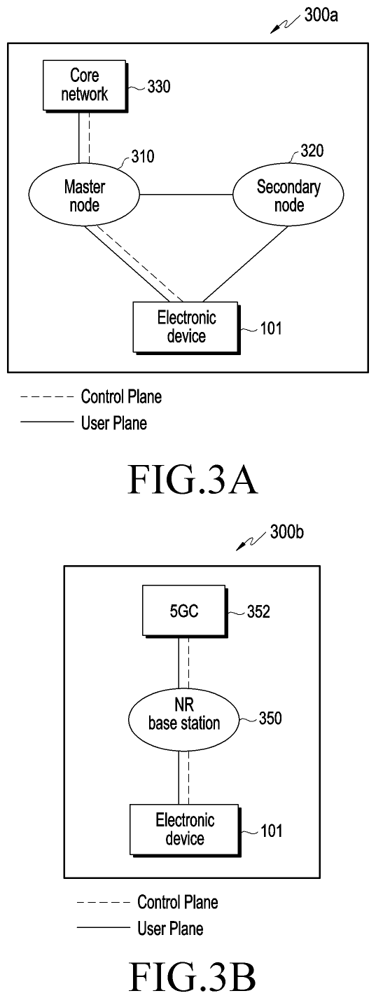

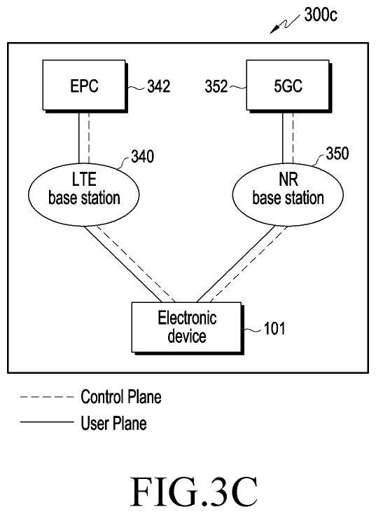

FIGS. 3A, 3B, and 3C are diagrams illustrating wireless communication systems providing networks of legacy communication and/or 5G communication according to various embodiments of the disclosure.

Referring to FIGS. 3A, 3B, and 3C, network environments 300a, 300b, and 300c may include at least one of a legacy network and a 5G network. The legacy network may include, for example, a 4G or LTE eNodeB (eNB) 341 of the 3GPP standard supporting radio access with the electronic device 101 and an evolved packet core (EPC) 342 for managing 4G communication. The 5G network may include a New Radio (NR) base station 351 (for example, a gNodeB (gNB)) supporting radio access with the electronic device 101 and a 5^{th} Generation Core (5GC) 352 for managing 5G communication of the electronic device 101.

The electronic device 101 may transmit and receive a control message and user data through legacy communication and/or 5G communication. The control message may include a message related to at least one of security control, bearer setup, authentication, registration, or mobility management of the electronic device 101. The user data may be user data other than the control message transmitted and received between, for example, the electronic device 101 and the core network 330 (e.g., EPC 342).

Referring to FIG. 3A, the electronic device 101 may transmit and receive at least one of a control message or user data to and from at least one of the 5G network (e.g., the NR gNB 351 and the 5GC 352) using at least some of the legacy network (e.g., the LTE eNB 341 and the EPC 342).

The network environment 300a may include a network environment for providing wireless communication Dual Connectivity (DC) to the LTE eNB 341 and the NR gNB 351 and transmitting and receiving a control message to and from the electronic device 101 through one core network 230 of the EPC 342 or the 5GC 352.

In the DC environment, one of the LTE eNB 341 or the NR gNB 351 may operate as a master node (MN) 310, and the other may operate as a secondary node (SN) 320. The MN 310 may be connected to the core network 330 to transmit and receive a control message. The MN 310 and the SN 320 may be connected through a network interface to transmit and receive a message related to management of radio resources (for example, communication channels) to and from each other.

The MN 310 may include the LTE eNB 341, the SN 320 may include the NR gNB 351, and the core network 330 may include the EPC 342. For example, a control message may be transmitted and received through the LTE eNB 341 and the EPC 342, and user data may be transmitted and received through at least one of the LTE eNB 341 or the NR gNB 351.

The MN 310 may include the NR gNB 351, the SN 320 may include the LTE eNB 341, and the core network 330 may include the 5GC 352. For example, a control message may be transmitted and received through the NR gNB 351 and the 5GC 352, and user data may be transmitted and received through at least one of the LTE eNB 341 or the NR gNB 351.

Referring to FIG. 3B, the 5G network may include the NR gNB 351 and the 5GC 352, and may transmit and receive a control message and user data independently from the electronic device 101.

Referring to FIG. 3C, each of the legacy network and the 5G network may independently provide data transmission and reception. For example, the electronic device 101 and the EPC 342 may transmit and receive a control message and user data through the LTE eNB (e.g., LTE base station 340). In another example, the electronic device 101 and the 5GC 352 may transmit and receive a control message and user data through the NR gNB (e.g., NR base station 350).

The electronic device 101 may be registered in at least one of the EPC 342 or the 5GC 352 to transmit and receive a control message.

The EPC 342 or the 5GC 352 may interwork with each other to manage communication of the electronic device 101. For example, movement information of the electronic device 101 may be transmitted and received through an interface between the EPC 342 and the 5GC 352.

As described above, the dual connection through the LTE eNB 341 and the NR gNB 351 may be also named evolved-universal terrestrial radio access (E-UTRA) new radio dual connectivity (EN-DC).

In various embodiments of the disclosure described below, EN-DC is described as an example, but the same or similar application may be provided to various types of multi-radio dual connectivity (MR-DC) including NR-E UTRA dual connectivity (NE-DC).

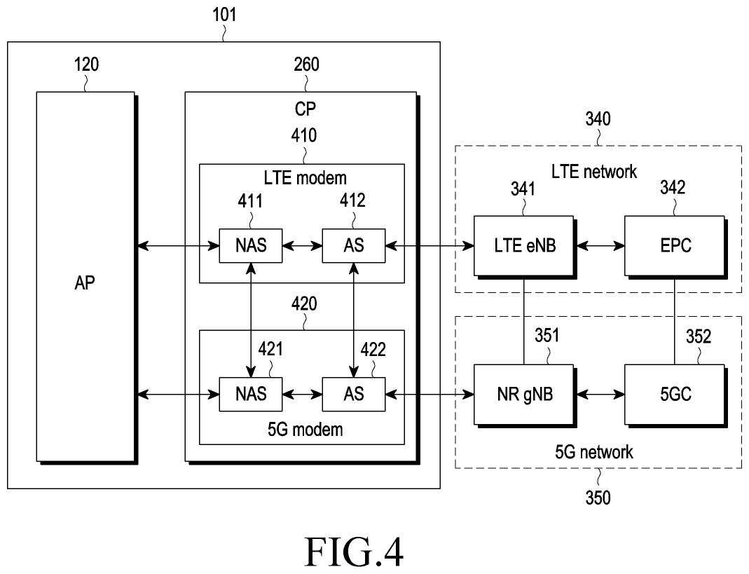

Hereinafter, a method by which an electronic device controls a connection with a network according to various embodiments is described with reference to FIGS. 4 to 17. Methods described below may be performed through the electronic device 101 of FIGS. 1, 2A, 2B, and 3A to 3C.

FIG. 4 is a block diagram illustrating an electronic device according to an embodiment of the disclosure.

Referring to FIG. 4, the electronic device 101 may include the processor 120 (e.g., an application processor (AP) and a communication processor (CP) (e.g., the integrated communication processor 260)). The communication processor 260 may include an LTE modem 410 and a 5G modem 420. Although FIG. 4 illustrates that one integrated communication processor 260 includes the LTE modem 410 and the 5G modem 420, the plurality of communication processors 212 and 214 may include the LTE modem 410 and the 5G modem 420, respectively, as illustrated in FIG. 2A. For example, the LTE modem 410 may correspond to the first communication processor 212 or may be included in the first communication processor 212, and the 5G modem 420 may correspond to the second communication processor 214 or may be included in the second communication processor 214.

The LTE modem 410 may include an LTE communication protocol stack. For example, the LTE modem 410 may include a non-access stratum (NAS) 411 and an access stratum (AS) 412. At least one operation performed by the NAS 411 and/or the AS 412 may be performed by at least one of the first communication processor 212 or the integrated communication processor 260 of the electronic device 101. The 5G modem 420 may include a 5G communication protocol stack. For example, the 5G modem 420 may include a non-access stratum (NAS) 421 and an access stratum (AS) 422. At least one operation performed by the NAS 421 and/or the AS 422 may be performed by at least one of the second communication processor 214 or the integrated communication processor 260 of the electronic device 101.

The NASs 411 and 421 may correspond to a layer for transmitting and receiving signaling or a traffic message to and from the electronic device 101 and the EPC 342 of the LTE network 340 or the 5GC 352 of the 5G network 350 in the LTE protocol stack or the 5G protocol stack. The NASs 411 and 421 may transfer relevant information or data to the processor 120 on the basis of a message received through the ASs 412 and 422. The AS 412 and the AS 422 may correspond to a layer related to access of the LTE eNB 341 of the LTE network 340 or the NR gNB 351 of the 5G network 350. For example, the AS 412 and the AS 422 may include layers of radio resource control (RRC), packet data convergence protocol (PDCP), radio link control (RLC), medium access control (MAC), and physical (PHY). The PDCP may serve to perform an operation such as IP header compression/reconstruction. The RLC may reconfigure a PDCP packet data unit (PDU) to be a suitable size and perform an ARQ operation. The MAC may perform an operation of multiplexing RLC PDUs to the MAC PDU and demultiplexing the MAC PDU to RLC PDUs. The PHY may perform an operation of channel-coding and modulating higher layer data to generate OFDM symbols, transmitting the OFDM symbols through a radio channel or demodulating and channel-decoding the OFDM symbols received through the radio channel, and transmitting the demodulated and channel-decoded OFDM symbols to the higher layer.

The electronic device 101 (e.g., at least one of the processor 120, the first communication processor 212, the second communication processor 214, the integrated communication processor 260, or an integrated SoC (not shown)) may receive an RRC connection reconfiguration (or RRC reconfiguration) message from the LTE network 340 or the 5G network 350. The electronic device 101 may reconfigure settings of the RRC connection on the basis of the RRC connection reconfiguration message. In this specification, the RRC connection reconfiguration message may include one of an RRC connection reconfiguration message or an RRC reconfiguration message. The electronic device 101 may establish an RRC Connection with, for example, the LTE network 340 or the 5G network 350 and then receive the RRC connection reconfiguration message. The electronic device 101 may transmit an RRC connection reconfiguration complete message indicating completion of the reconfiguration to the LTE network 340 or the 5G network 350. The LTE network 340 or the 5G network 350 may be a base station (e.g., at least one of the eNB 341, the gNB 351, an ng-eNB, or an en-gNB) corresponding to communication for configuring, for example, the RRC connection reconfiguration message, but when some of the functions of the base station are virtualized, may be implemented as at least a portion of hardware for the radio control and a server for performing a virtualized function. The LTE network 340 or the 5G network 350 may also be named a serving cell.

A process of the RRC connection reconfiguration may be for configuring the RRC connection reconfiguration (e.g., configuring, controlling, and/or releasing a resource block (RB)), performing the reconfiguration along with synchronization, setting, controlling, and/or releasing measurement, and adding, controlling, and/or releasing an SCell and a cell group. As a portion of the process of the RRC connection reconfiguration, NAS-dedicated information may be transmitted from the LTE network 340 or the 5G network 350 to the electronic device 101. When the electronic device 101 is in, for example, an RRC-connected state (RRC_CONNECTED state), the LTE network 340 or the 5G network 350 may perform the RRC connection reconfiguration procedure. For example, when a measurement configuration (for example, 3GPP TS 38.331 or measConfig of 36.331) is included in the RRC connection reconfiguration message, the electronic device 101 may perform a measurement configuration procedure (e.g., measurement configuration procedure configured as disclosed in 3GPP TS 38.331 or 36.331).

As described above, the LTE network 340 or the 5G network 350 according to various embodiments of the disclosure may configure the electronic device 101 in the RRC-connected state to perform measurement and report according to the measurement configuration. The measurement configuration may be provided through UE-dedicated RRC signaling, for example, the RRC connection reconfiguration message. For example, when the electronic device 101 performs 3GPP LTE communication with the LTE network 340 or communication for controlling dual connectivity is configured as 3GPP LTE communication, the electronic device 101 may make a request for measuring the following types:
Intra-frequency measurements: measurement in downlink carrier frequency(s) of serving cell(s)
Inter-frequency measurements: measurement in frequencies different from any frequency among downlink carrier frequency(s) of serving cell(s)
Measurement in frequency in inter-RAT (for example, NR, UTRA, GERAN, CDMA 2000 HRPD, or DCMA 2000 I×RTT)

For example, when the electronic device 101 performs 5G communication with the 5G network 350 or communication for controlling dual connectivity is configured as 5G communication, the electronic device 101 may measure the following types:
NR measurement, for example, intra-frequency measurement, and/or inter-frequency measurement in NR
Inter-RAT measurement E-UTRA frequency

In the measurement configuration, information on a measurement object (MO) may be included. The measurement object may include subcarrier spacing of a reference signal to be measured and a frequency/time location. The electronic device 101 may identify a frequency for measurement on the basis of the measurement object within the measurement configuration. The measurement object may include a measurement object identity that is information indicating a frequency to be measured (for example, ARFCN-ValueEUTRA and/or ARFCN-ValueNR) or a cell black list and/or a cell white list.

The measurement configuration of the RRC connection reconfiguration message may include a reporting configuration. For example, the reporting configuration may include at least one of a reporting criterion, a reporting format, or an RS type, but there is no limitation. The reporting criterion is a condition for triggering a UE to transmit a measurement report and may be periodic or single event description. The reporting format may be information on the number of reports which the UE includes in the measurement report and relevant information (e.g., the number of cells to be reported) in LTE communication. The reporting format may be information on the number per cell and per beam to be included in the measurement report and other relevant information (e.g., the maximum number of beams per cell to be reported and the maximum number of cells). The RS type may indicate an RS of a beam to be used by the UE and a measurement result.

The measurement configuration of the RRC connection reconfiguration message may include at least one of a measurement identity, a quantity configuration, or a measurement gap. The measurement identify may be a list of measurement identifies related to the measurement object. The quantity configuration may define a measurement filtering configuration and a periodic measurement report used in all event evaluations and relevant reports. The measurement gap is a period of measurement by the UE, and may be, for example, an interval in which uplink or downlink transmission is not scheduled.

The RRC-connected electronic device 101 may measure the measurement object. For example, the electronic device 101 may measure at least one of an RSRP, an RSRQ, an RSSI, or an SINR corresponding to at least one of an inter-frequency, an intra-frequency, or an inter-RAT on the basis of the measurement configuration corresponding to each serving cell. In the disclosure, the measurement of a communication signal by the electronic device 101 may be measurement of at least one of an RSRP, an RSRQ, an RSSI, or an SINR at a reference point for a communication signal from the outside.

According to various embodiments of the disclosure, the measurement of an RSRP by the electronic device 101 may be the identification of an RSRP measurement value by at least one of the processor 120, the first communication processor 212, the second communication processor 214, the integrated communication processor 260, or an integrated SoC (not shown), but there is no limitation. For example, the electronic device 101 may identify a linear average of power distribution in units of watts (W) of resource elements carrying at least one of a reference signal or a synchronization signal within a frequency bandwidth to be measured as an RSRP measurement value. Any signal defined in the 3GPP can be used for the reference signal and the synchronization signal. For example, the electronic device 101 may identify the RSRP measurement value on the basis of a linear average of power distribution at a reference point. For example, in LTE communication, the electronic device 101 may identify the RSRP measurement value on the basis of the linear average of power distribution at an antenna connector of an antenna (e.g., the first antenna module 242) for receiving the corresponding communication signal. For example, in FR1 of NR, the electronic device 101 may identify the RSRP measurement value on the basis of the linear average of power distribution at an antenna connector of an antenna (e.g., the first antenna module 244) for receiving the corresponding communication signal. For example, in FR2 of NR, the electronic device 101 may identify a measurement value (e.g., synchronization signal-reference signal received power (SS-RSRP) on the basis of a combined signal from an antenna element (e.g., at least one antenna element of the antennas 248) corresponding to a given receiver branch.

According to various embodiments of the disclosure, the electronic device 101 may include at least one sensor (e.g., at least one of a voltage sensor, a current sensor, or a power sensor) at a reference point (e.g., an antenna connector), and may measure power at a reference point on the basis of sensing data from at least one sensor. As described above, since there is no limitation on the reference point, there is no limitation on a location to which at least one sensor is connected.

The measurement of an RSRQ by the electronic device 101 may be the identification of an RSRQ measurement value by at least one of the processor 120, the first communication processor 212, the second communication processor 214, the integrated communication processor 260, or an integrated SoC (not shown), but there is no limitation. For example, the electronic device 101 may measure the RSRQ on the basis of [Equation 1] below.

RSRQ=N×RSRP/RSSI Equation 1

An RSSI is an RSSI of a carrier, and may be a linear average of received total power observed in a specific OFDM symbol of a measurement subframe in a measurement bandwidth for N resource blocks and may include adjacent channel interference and thermal noise. N may be the number of resource blocks. The electronic device 101 may measure the RSSI and the RSRP and identify the RSRQ therefrom. Alternatively, the electronic device 101 may measure the SINR on the basis of power of a signal of a serving cell compared to noise based on an RS of the serving and PDSCH power.

Through the operation, the electronic device 101 may identify the measurement result from, for example, a physical layer, and may determine whether the reporting criterion is satisfied on the basis of the measurement result. The electronic device 101 may perform filtering (e.g., layer 3 filtering) on the performance result and determine whether the reporting criterion is satisfied on the basis of the filtering result. [Equation 2] below indicates a layer 3 filtering process.

Fₙ=(1−a)*Fₙ₋₁+a*Mₙ Equation 2

Mₙ may be a measurement result (e.g., RSRP and/or RSRQ) most recently received from a physical layer. Fn is an updated filtered measurement result and may be used for evaluating a measurement report or a reporting criterion. Fₙ₋₁ may be the existing filtered measurement result. When a first measurement result is received from the physical layer, F₀ may be configured as M₁, a is ½^{(ki/4)}, wherein ki may be a filtering coefficient corresponding to a measurement quantity of an i^{th} quantity configuration in a quantity configuration list and i may be a quantity configuration index of a measurement object. In various embodiments of the disclosure, the “measurement result” may refer to at least one of a value acquired from the physical layer or a value obtained by filtering the value acquired from the physical layer.

The electronic device 101 may determine whether the measurement result satisfies the reporting criterion. The reporting criterion may be described below but other criteria may also be used.
Event A1: Serving becomes better than threshold
Event A2: Serving becomes worse than threshold
Event A3: Neighbour becomes offset better than PCell/PSCell (or SpCell of NR)
Event A4: Neighbour becomes worse than threshold
Event A5: PCell/PSCell (or SpCell of NR) becomes worse than threshold1 and neighbour (or, neighbour/SCell of NR) becomes better than threshold2
Event A6: Neighbour becomes offset better than Scell (or S cell of NR)
Event B1: Inter RAT neighbour becomes better than threshold
Event B2: PCell becomes worse than threshold1 and inter RAT neighbour becomes better than threshold2

The reporting criteria may follow, for example, 3GPP TS 36.331 or 3GPP TS 38.331, but there is no limitation on the type thereof.

The electronic device 101 need not always perform measurement which should be performed by the measurement configuration and may perform the same according to a measurement period.

The electronic device 101 may transmit a measurement report message to the LTE network 340 or the 5G network 350 (e.g., serving cell) on the basis of satisfaction of the reporting criterion. For example, when the reporting criterion satisfied among the reporting criteria is maintained while a timer corresponding to a time-to-trigger value is running (e.g., before the time expires), the electronic device 101 may transmit the measurement report message to the LTE network 340 or the 5G network 350. The electronic device 101 may configure the measurement result within the measurement report message (e.g., measResults of 3GPP TS 38.331 or 3GPP TS 36.331) for a measurement identity for which the measurement report procedure is triggered. An information element (IE) of the measurement result may include the result measured for intra-frequency, inter-frequency, and an inter-RAT mobility (for example, at least one of the RSRP, the RSRQ, or the SINR). For example, the measurement report message may include the measurement identity and the measurement result.

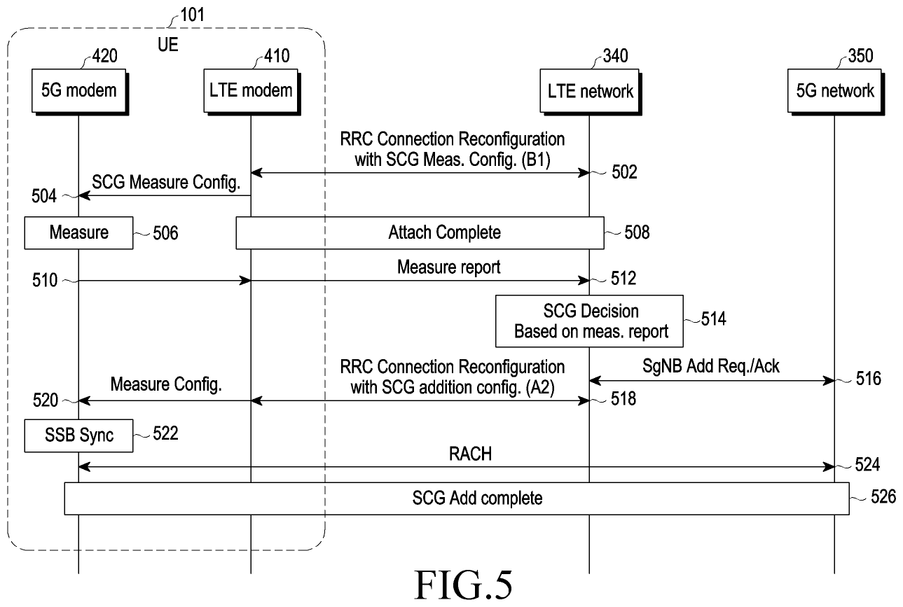

FIG. 5 is a flowchart illustrating an operation in which an electronic device accesses a communication network according to an embodiment of the disclosure.

Referring to FIG. 5, the electronic device 101 (e.g., a user equipment (UE) may include the 5G modem 420 (e.g., the second communication processor 214 of FIG. 2A) and the LTE modem 410 (e.g., the first communication processor 212 of FIG. 2A). Although the 5G modem 420 and the LTE modem 410 are expressed as separate blocks in FIG. 5, the 5G modem 420 and the LTE modem 410 may be implemented in the form of separate processors (e.g., chips) such as the second communication processor 214 and the first communication processor 212 as illustrated in FIG. 2A, or may be implemented in the form of one processor such as the integrated communication processor 260 as illustrated in FIG. 2B. They are illustrated as separate blocks for convenience in FIG. 5, but are not limited only to physical division. The LTE modem 410 may perform RRC connection reconfiguration to configure a secondary cell group (SCG) measurement information (SCG Meas.) report condition as event B1 with the LTE network 340 (e.g., master node 310 of FIG. 3A) in operation 502. Event B1 may indicate an event that measurement information corresponding to a neighboring node in different type (inter RAT neighbor) is larger than a threshold value (e.g., reference signal received power (RSRP) of −120 dBm). In operation 504, the LTE modem 410 may configure the SCG measurement report condition (SCG measure config.). The 5G modem 420 may measure a plurality of measurement objects (MOs) in operation 506. The LTE modem 410 may complete attach with the LTE modem 340 in operation 508. When it is identified that event B1 is satisfied (e.g., when reference signal received power (RSRP) of a received signal for a frequency corresponding to a specific MO is larger than −120 dBm), the 5G modem 420 and the LTE modem 410 may transfer a measurement report (MR) to the LTE network 340 in operation 510 and operation 512. For example, the electronic device 101 may transfer cell identification information (or node identification information) for an amount of measurement exceeding the threshold value to the LTE network 340.

In operation 514, the LTE network 340 may determine the SCG on the basis of the measurement report (meas. Report). For example, the LTE network 340 may select the 5G network 350 (e.g., secondary node 320 of FIG. 3A). The LTE network 340 may make a request for adding an SgNB to the 5G network and receive ack therefor in operation 516. The LTE network 340 may perform RRC connection reconfiguration with SCG including a reporting criterion of event A2 in the electronic device 101 in operation 518. The 5G modem 420 may configure the reporting criterion in operation 520. In operation 522, the 5G modem 420 may perform SSB synchronization. The electronic device 101 may perform RACH (e.g., contention free (CF) RACH or contention-based RACH) with the 5G network 350 in operation 524. In operation 526, the electronic device 101 may complete addition of the SCG with the LTE network 340 and the 5G network 350.

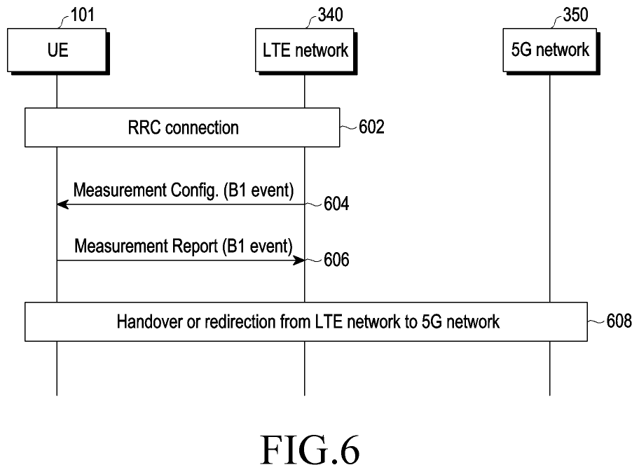

FIG. 6 is a flowchart illustrating an operation in which an electronic device accesses a communication network according to an embodiment of the disclosure.

Referring to FIG. 6, the electronic device 101 ((UE) may make an RRC connection with the LTE network 340 in operation 602 and thus may be in an RRC-connected state (RRC CONNECTION state).

The LTE network 340 may transmit information related to the measurement configuration to the electronic device 101 in operation 604, and the information related to the measurement configuration may include B1 event information.

After identifying the measurement configuration and performing measurement corresponding to the measurement object included in the measurement configuration, the electronic device 101 may transmit a measurement report (MR) to the LTE network 340 on the basis of the measurement result in operation 606.

The LTE network 340 may receive the measurement report from the electronic device 101 and, when the measurement report is suitable for a condition of handover or redirection to the 5G network 350, the LTE network 340 may perform handover or redirection to the 5G network 350 from the LTE network 340 in operation 608. The electronic device 101 may perform handover or redirection to the 5G network 350 from the LTE network 340.

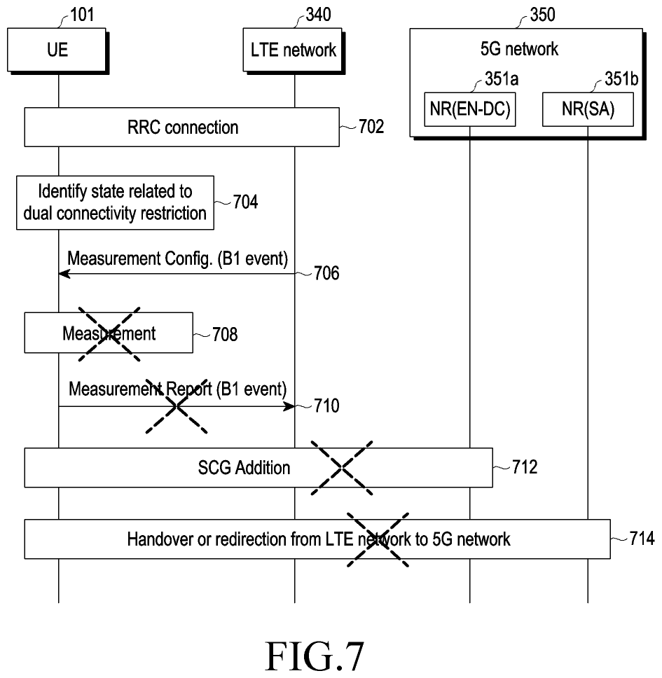

FIG. 7 is a flowchart illustrating an operation in which an electronic device accesses a communication network according to an embodiment of the disclosure.

Referring to FIG. 7, the electronic device 101 may make an RRC connection with the LTE network 340 in operation 702 and thus may be in an RRC-connected state (RRC CONNECTION state).

The electronic device 101 may identify a state related to dual connectivity restriction in operation 704. For example, the CP 260 of the electronic device 101 may receive event information or state information related to dual connectivity restriction from the AP 120. The state information of the electronic device related to the dual connectivity restriction may include at least one of an on/off state of a display and a state in which throughput (TPUT) of network communication data is equal to or smaller than a configured value. For example, when throughput in the on state of the display is smaller than a first threshold value (e.g., 40 Mbps), the electronic device 101 may identify the state related to the dual connectivity restriction. When throughput in the off state of the display is smaller than a second threshold value (e.g., 10 kbps), the electronic device 101 may identify the state related to the dual connectivity restriction. The first threshold value and the second threshold value may be the same as each other or different from each other. The state information of the electronic device related to the dual connectivity restriction may include a state in which a battery charge is equal to or lower than a configured value (e.g., 15%) or a state in which temperature is higher than a configured value.

When the state related to the dual connectivity restriction is identified, the electronic device 101 may restrict the dual connectivity. In order to restrict the dual connectivity, the electronic device may control not to perform measurement related to B1 event or control not to report the measurement result related to B1 event to the base station.

The LTE network 340 may transmit information related to the measurement configuration to the electronic device 101 in operation 706, and the information related to the measurement configuration may include B1 event information.

The electronic device 101 receives information related to the measurement configuration, but may block measurement corresponding to the measurement object included in the measurement configuration according to identification of the state related to the dual connectivity restriction in operation 708. The electronic device 101 may transmit the measurement report (MR) to the LTE network 340 on the basis of the measurement result according to the non-performance of the measurement for the measurement object in operation 710.

The LTE network 340 may perform a dual connectivity operation with the 5G network 350 according to non-reception of the measurement report from the electronic device 101. For example, the electronic device 101 may perform SCG addition with a base station (e.g., NR (EN-DC) supporting base station 351a) of the 5G network 350 through the LTE network 340 in operation 712.

According to various embodiments of the disclosure, the electronic device 101 need not measure the measurement object in operation 708 but may perform handover or redirection to the base station of the 5G network 350 (e.g., NR (SA) base station 351b) in operation 714 according to non-transmission of the measurement report (MR) to the LTE network 340 based on the measurement result in operation 710. The NR (EN-DC) base station 351a and the NR (SA) base station 351b may be the same base stations or different base stations.

As illustrated in FIG. 7, the dual connectivity restriction by limit on B1 event of the electronic device 101 may cause limit on the handover or redirection to the 5G network by the SA scheme, and the connection to the 5G network by the SA scheme may have smaller power consumption compared to the dual connectivity.

As described below, when the electronic device is in a state related to dual connectivity restriction, a method of enabling a handover or redirection to the 5G network in the state related to the dual connectivity restriction is described by not restricting dual connectivity by restriction related to a B1 event and changing a configuration related to the dual connectivity restriction.

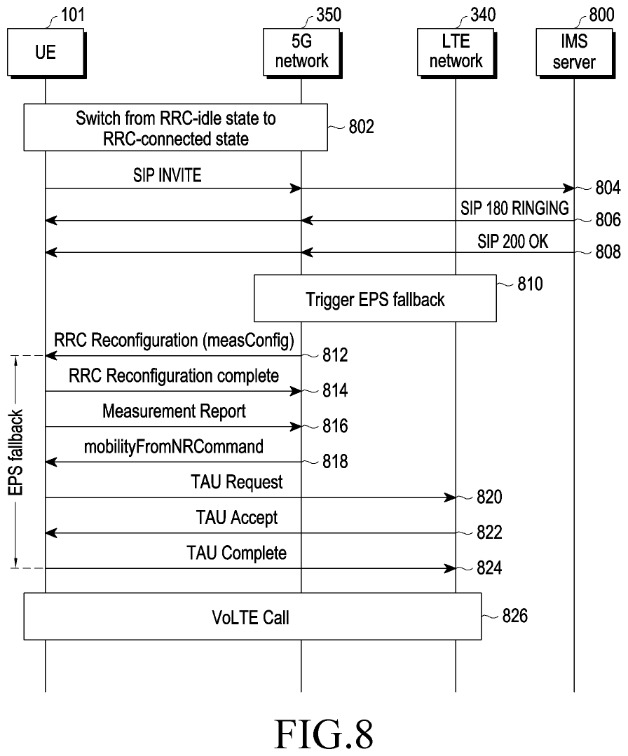

Hereinafter, a situation related to dual connectivity restriction generated during VoLTE through EPS fallback according to a call request during a 5G network connection is described with reference to FIGS. 8, 9, and 10.

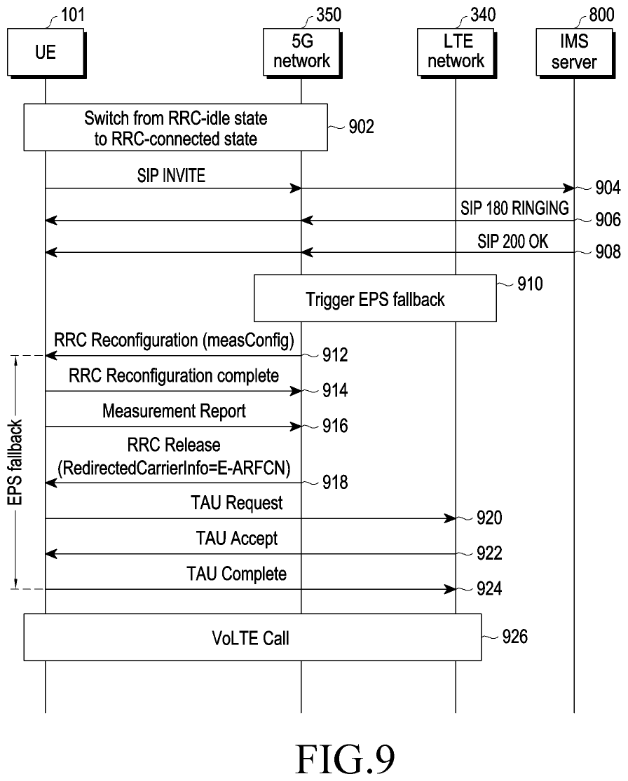

According to various embodiments of the disclosure, the EPS fallback or RAT fallback may be performed in the form of handover as illustrated in FIG. 8 or performed in the form of redirection as illustrated in FIG. 9 according to network implementation and a service provider policy.

FIG. 8 is a signal flowchart illustrating handover-based EPS fallback operations according to an embodiment of the disclosure.

Referring to FIG. 8, the electronic device 101 (e.g., a UE at a transmitting side (MO UE)) and the 5G network 350 may switch from an RRC-idle state to an RRC-connected state in operation 802 according to a call request from a user. The electronic device 101 may transmit an SIP INVITE message to an IMS server 800 through the 5G network 350 in operation 804. Although not illustrated in FIG. 8, the 5G network 350 may transmit a paging signal to the electronic device at the receiving side (e.g., MT UE), and the electronic device at the receiving side may switch from the idle state to the active state according to reception of the paging signal and receive an SIP INVITE message transmitted from the electronic device 101 at the transmitting side. The electronic device at the receiving side may receive the SIP INVITE message and transmit an SIP 180 RINGING message to the IMS server 800. The IMS server 800 may transmit the SIP 180 RINGING message transmitted from the UE at the receiving side to the electronic device 101 which is the UE at the transmitting side through the 5G network 350 in operation 806. When the electronic device at the receiving side (MT UE) answers, an SIP 200 OK message may be transmitted to the IMS server 800. The IMS server 800 may transmit the SIP 200 OK message to the electronic device 101 through the 5G network 350 in operation 808.

The 5G network 350 may trigger EPS fallback in operation 810. When handover-based EPS fallback is configured in the 5G network 350 (for example, gNB 351), the 5G network 350 may transmit measConfig for measuring an LTE band to the electronic device 101 through an RRC reconfiguration in operation 812. The electronic device 101 may transmit RRC reconfiguration complete to the 5G network 350 in operation 814 according to reception of the RRC reconfiguration in operation 812. The electronic device 101 may report LTE measurement information measured on the basis of information (e.g., measurement object (MO)) included in the RRC reconfiguration to the 5G network 350 through a measurement report (MR) message in operation 816. The 5G network 350 may transmit an LTE band to be handed over by the electronic device 101 and cell information to the electronic device 101 through mobilityFromNRCommand on the basis of the received MR in operation 818.

The electronic device 101 may perform a tracking area update (TAU) procedure with the LTE network 340 (e.g., eNB 341/EPC 342) on the basis of the corresponding LTE band and cell information. For example, the electronic device 101 may transmit a TAU request to the LTE network 340 in operation 820 and receive a TAU accept from the LTE network 340 in operation 822. The electronic device 101 may receive the TAU accept and transmit TAU complete to the LTE network 340 in operation 824, so as to complete the inter-RAT handover process for EPS fallback. After the EPS fallback procedure is completed, the electronic device 101 and the LTE network 340 (e.g., eNB 341/EPC 342) may set up a VoLTE call in operation 826.

FIG. 9 is a signal flowchart illustrating redirection-based EPS fallback operations according to an embodiment of the disclosure.

Referring to FIG. 9, the electronic device 101 (e.g., an MO UE) and the 5G network 350 (e.g., gNB 351/5GC 352) may switch from an RRC-idle state to the RRC-connected state in operation 902 according to a call request from a user. The electronic device 101 may transmit an SIP INVITE message to an IMS server 800 through the 5G network 350 in operation 904. Although not illustrated in FIG. 9, the 5G network 350 may transmit a paging signal to the electronic device at the receiving side (for example, MT UE), and the electronic device at the receiving side may switch from the idle state to the active state according to reception of the paging signal and receive an SIP INVITE message transmitted from the electronic device 101 at the transmitting side. The electronic device at the receiving side may receive the SIP INVITE message and transmit an SIP 180 RINGING message to the IMS server 800. The IMS server 800 may transmit the SIP 180 RINGING message transmitted from the UE at the receiving side to the electronic device 101 which is the UE at the transmitting side (MO UE) through the 5G network 350 in operation 906. When the electronic device at the receiving side (MT UE) answers, an SIP 200 OK message may be transmitted to the IMS server 800. The IMS server 800 may transmit the SI 200 OK message to the electronic device 101 through the 5G network 350 in operation 908.

The 5G network 240 may trigger EPS fallback in operation 910. The 5G network 350 may transmit measConfig for measuring an LTE band to the electronic device 101 through an RRC reconfiguration in operation 912. The electronic device 101 may transmit RRC reconfiguration complete to the 5G network 350 in operation 914 according to reception of the RRC reconfiguration in operation 912. The electronic device 101 may report LTE measurement information measured on the basis of information (e.g., measurement object (MO)) included in the RRC reconfiguration to the 5G network 350 through a measurement report (MR) message in operation 916. When redirection-based EPS fallback is configured in the 5G network 350 (e.g., gNB 351), the 5G network 350 may insert a specific LTE E-absolute radio frequency channel number (ARFCN) into an RRC release message and transmit the RRC release message to the electronic device 101 in operation 918. After moving to the LTE communication network and performing cell scan on the corresponding E-ARFCN, the electronic device 101 may perform a TAU procedure for camping on one cell. For example, the electronic device 101 may perform the TAU procedure with the corresponding LTE communication network 340 (e.g., eNB 341/EPC 342) according to the cell scan. For example, the electronic device 101 may transmit a TAU request to the LTE network 340 in operation 920 and receive a TAU accept from the LTE network 340 in operation 922. The electronic device 101 may receive the TAU accept and transmit TAU complete to the LTE network 340 in operation 924, so as to complete the inter-RAT handover process for EPS fallback. After the EPS fallback procedure is completed, the electronic device 101 and the LTE network 340 may set up a VoLTE call in operation 926.

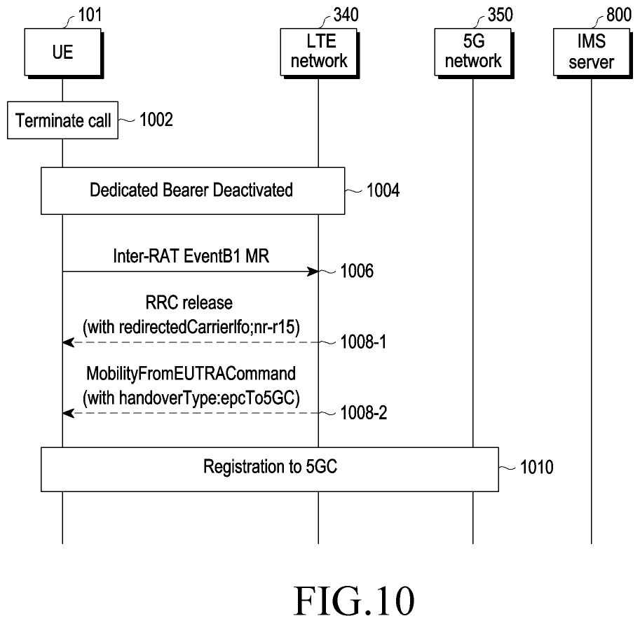

FIG. 10 is a signal flowchart illustrating operations for returning to a 5G communication network after an IMS voice call is terminated according to an embodiment of the disclosure.

Referring to FIG. 10, the call may be performed through the LTE network 340 after the EPS fallback according to FIG. 8 or FIG. 9, and returning to the 5G network 350 before the fallback may be performed according to termination of the call.

When the call is terminated for various reasons in operation 1002, a dedicated bearer between the electronic device 101 and the LTE network 340 (e.g., eNB 341/EPC 342) may be deactivated in operation 1004. The electronic device 101 may transmit an MR of a B1 event (for example, MR of an inter-RAT B1 event) to the LTE network 340 in operation 1006. When redirection is configured, the LTE network 340 receiving the MR in operation 1006 may release a connection with the LTE network 340 by transmitting an RRC release message including “redirectedCarrier1fo;nr-r15” to the electronic device 101 in operation 1008-1. On the other hand, when handover is configured, the LTE network 340 receiving the MR in operation 1006 may transmit MobilityFromEUTRACommand including “handoverType:epcTo5GC” to the electronic device 101 in operation 1008-2. The electronic device 101 may be registered in the 5G network 350 (for example, gNB 351/5GC 532) by the redirection or handover in operation 1010.

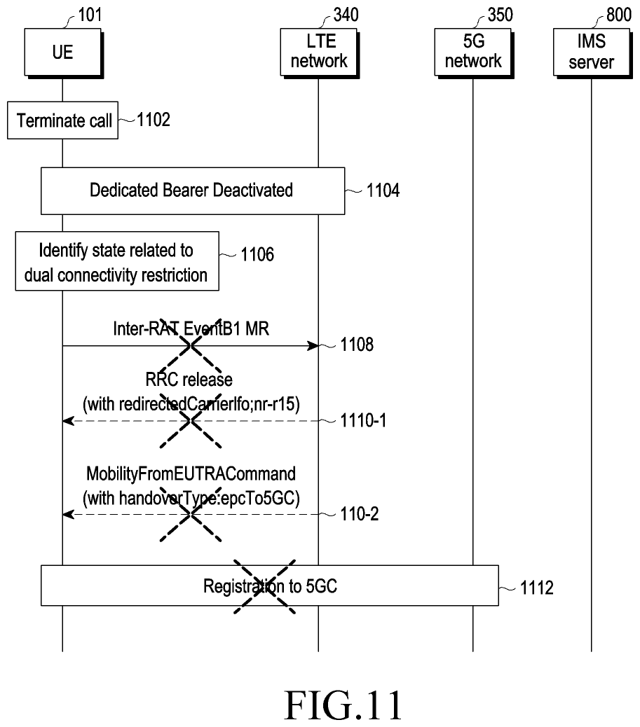

FIG. 11 is a flowchart illustrating an operation in which an electronic device accesses a communication network according to an embodiment of the disclosure.

Referring to FIG. 11, the call may be performed through the LTE network 340 after the EPS fallback according to FIG. 8 or FIG. 9, and returning to the 5G network 350 before the fallback may be performed according to termination of the call.

When the call is terminated for various reasons in operation 1102, a dedicated bearer between the electronic device 101 and the LTE network 340 (for example, eNB 341/EPC 342) may be deactivated in operation 1104.

The electronic device 101 may identify a state related to dual connectivity restriction in operation 1106. For example, the CP 260 of the electronic device 101 may receive event information or state information related to dual connectivity restriction from the AP 120. The state information of the electronic device related to the dual connectivity restriction may include at least one of an on/off state of a display and a state in which throughput (TPUT) of network communication data is equal to or smaller than a configured value. For example, when throughput in the on state of the display is equal to or smaller than a first threshold value (e.g., 40 Mbps), the electronic device 101 may identify the state related to the dual connectivity restriction. When throughput in the off state of the display is smaller than a second threshold value (e.g., 10 kbps), the electronic device 101 may identify the state related to the dual connectivity restriction. The first threshold value and the second threshold value may be the same as each other or different from each other. The state information of the electronic device related to the dual connectivity restriction may include a state in which a battery charge is equal to or lower than a configured value (e.g., 15%) or a state in which temperature is higher than a configured value.

The electronic device may perform control not to perform measurement related to the B1 event for the dual connectivity restriction or perform control not to report the measurement report (MR) related to the B1 event to the base station in response to identification of the state related to the dual connectivity restriction. For example, the electronic device 101 may perform control not to transmit the MR of the B1 event (e.g., MR of inter-RAT B1 event) to the LTE network 340 in operation 1108. When the LTE network 340 is configured as the redirection, the LTE network 340 cannot receive the MR in operation 1108 and thus cannot transmit an RRC release message including “redirectedCarrier1fo;nr-r15” to the electronic device 101 in operation 1110-1, so as not to perform a registration procedure for the 5GC network 350 in operation 1112. When the LTE network 340 is configured as the handover, the LTE network 340 cannot receive the MR in operation 1108 and thus cannot transmit MobilityFromEUTRACommand including “handoverType:epcTo5GC” to the electronic device 101 in operation 1110-2, so as not to perform a registration procedure for the 5GC network 350 in operation 1112.

The electronic device 101 does not measure the measurement object but may perform the handover or redirection to the 5G network 350 in operation 1112 according to non-transmission of the measurement report (MR) to the LTE network 340 based on the measurement result in operation 1108.

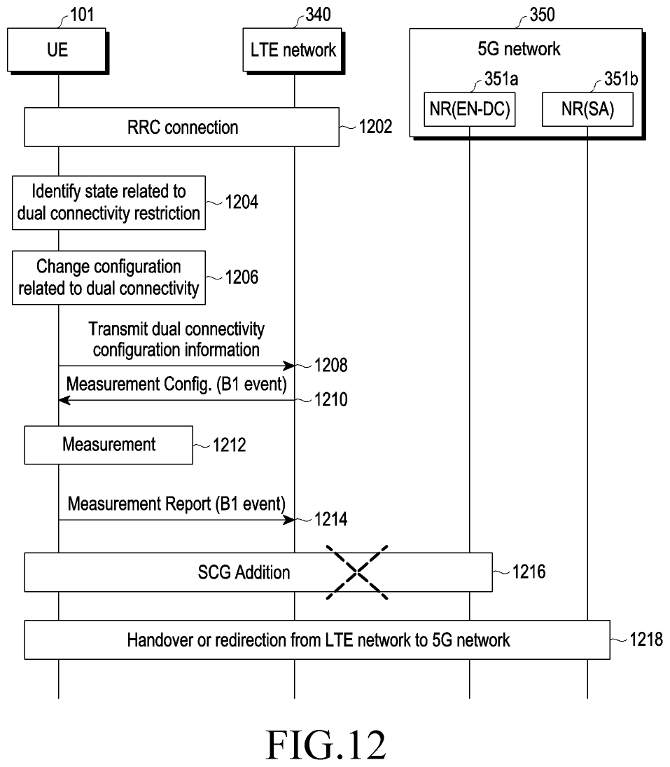

FIG. 12 is a flowchart illustrating an operation in which an electronic device accesses a communication network according to an embodiment of the disclosure.

Referring to FIG. 12, the electronic device 101 (UE) may make an RRC connection with the LTE network 340 in operation 1202 and thus may be in an RRC-connected state (RRC CONNECTION state).

The electronic device 101 may identify a state related to dual connectivity restriction in operation 1204. For example, the CP 260 of the electronic device 101 may receive event information or state information related to dual connectivity restriction from the AP 120. The state information of the electronic device related to the dual connectivity restriction may include at least one of an on/off state of a display and a state in which throughput (TPUT) of network communication data is equal to or smaller than a configured value. For example, when throughput in the on state of the display is equal to or smaller than a first threshold value (e.g., 40 Mbps), the electronic device 101 may identify the state related to the dual connectivity restriction. When throughput in the off state of the display is smaller than a second threshold value (e.g. 10 kbps), the electronic device 101 may identify the state related to the dual connectivity restriction. The first threshold value and the second threshold value may be the same as each other or different from each other. The state information of the electronic device related to the dual connectivity restriction may include a state in which a battery charge is equal to or lower than a configured value (e.g., 15%) or a state in which temperature is higher than a configured value. State information (e.g., display off state information) of the electronic device 101 related to dual connectivity restriction of the electronic device 101 or event information may be determined on the basis of inter-process communication (IPC) information that can be acquired by a processor (e.g., the processor 120, the first communication processor 212, the second communication processor 214, or the integrated communication processor 260).

When the state related to the dual connectivity restriction is identified, the electronic device 101 may change a configuration related to dual connectivity in operation 1206. For example, the electronic device may change the configuration related to dual connectivity from a first state (e.g., NR NSA mode+NR SA mode) to a second state (for example, NR SA only mode). The electronic device may change the NR NSA mode related to dual connectivity from an enabled state to a disabled state. The operation for changing the mode may include at least one of an operation for changing a state value of at least one flag indicating the state of the electronic device 101 and an operation for executing an instruction of configuring the state of the electronic device 101, but there is no limitation. For example, the change in at least one operation performed by the electronic device 101 may be a mode change for convenience. Alternatively, the mode of the electronic device 101 may be replaced with the state of the electronic device 101. The electronic device 101 may change the NR NSA mode from the enabled state to the disabled state according to the mode change. For example, the electronic device 101 may switch to a state that is the same as an electronic device which does not internally support dual connectivity (for example, EN-DC) with NR. The electronic device 101 may change and display a list which does not have a mode including NR NSA in the configuration of a user network mode according to the switching or may display a menu for selecting NSA in a deactivated state (for example, gray processing).

The first state (e.g., NR NSA mode+NR SA mode) may be configured as shown in Table 1 below.

TABLE 1

N1Mode = 1 => SA
DCNR = 1 => NSA
Dual connectivity of E-UTRA with NR capability = 1 => NSA

In Table 1 above, “N1Mode” is a configuration related to SA and may indicate that NR SA is enabled when it is configured as “1”. “DCNR” is a configuration related to NSA and may indicate that NR NSA is enabled when it is configured as “1”. “Dual connectivity of E-UTRA with NR capability” is a configuration related to NSA and may indicate that NR NSA is enabled when it is configured as “1”.

When the first state is changed to the second state (e.g., NR SA only mode), Table 1 above may be changed to Table 2 below.

TABLE 2

N1Mode = 1 => SA
DCNR = 0 => NSA
Dual connectivity of E-UTRA with NR capability = 0 => NSA

In Table 2 above, “N1Mode” is a configuration related to SA and may indicate that NR SA is enabled when it is configured as “1”. “DCNR” is a configuration related to NSA and may indicate that NR NSA is disabled (for example, deactivated) when it is configured as “0”. “Dual connectivity of E-UTRA with NR capability” is a configuration related to NSA and may indicate that NR NSA is disabled when it is configured as “0”.

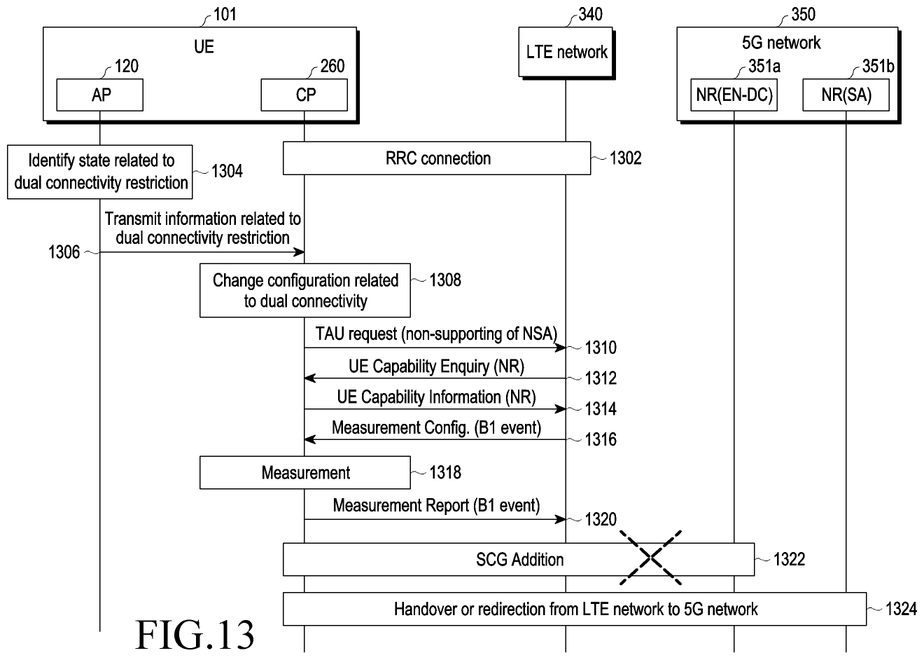

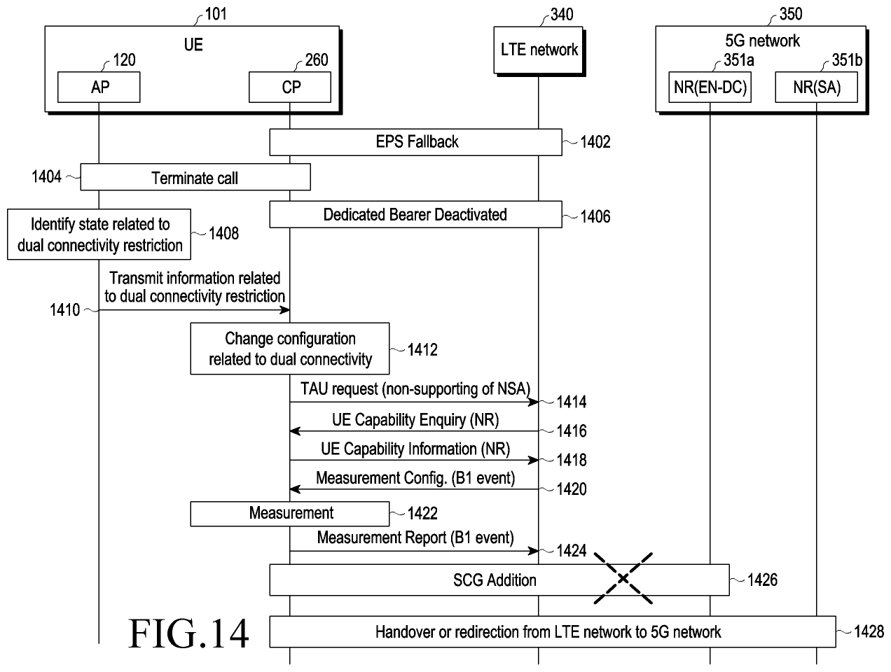

The electronic device 101 may transmit configuration information related to the dual connectivity to the LTE network 340 in operation 1208. For example, the electronic device 101 may change the configuration in Table 1 to the configuration in Table 2 according to identification of the state related to dual connectivity restriction and transmit dual connectivity configuration information including information corresponding to the configuration in Table 2 to the LTE network 340. The dual connectivity configuration information may be transmitted to the LTE network 340 through a tracking area update (TAU) request message. A detailed description thereof is provided below with reference to FIGS. 13 and 14.

The LTE network 340 may identify the dual connectivity configuration information and may transmit a measurement configuration including a B1 event for the NR SA connection to the electronic device 101 in operation 1210 since NR NSA is disabled for the electronic device 101 but NR SA is enabled.

The electronic device may receive the measurement configuration including the B1 event from the LTE network 340 and identify a measurement object corresponding to the B1 event included in the measurement configuration. The electronic device 101 may measure the identified measurement object in operation 1212 and may transmit a measurement report (MR) to the network 340 in operation 1214.

The electronic device 101 may not perform an NR NSA procedure with the NR (EN-DC) base station 351a by SCG addition in operation 1216 but may perform an NR SA procedure with the NR (SA) base station 351b in operation 1218 by transmitting the measurement for NR SA and the measurement report to the LTE network 340. For example, the electronic device 101 may perform a handover or redirection procedure from the LTE network 340 to the 5G network 350 in operation 1218. Referring to FIG. 12, the NR (EN-DC) base station 351a and the NR (SA) base station 351b may be different base stations or may be the same base stations.

FIG. 13 is a flowchart illustrating an operation in which an electronic device accesses a communication network according to an embodiment of the disclosure.

Referring to FIG. 13, the CP 260 of the electronic device 101 may make an RRC connection with the LTE network 340 in operation 1302 and thus may be in an RRC-connected state (RRC CONNECTION state).

The AP 120 of the electronic device 101 may identify a state related to dual connectivity restriction in operation 1304. The state information of the electronic device related to the dual connectivity restriction may include at least one of an on/off state of a display and a state in which throughput (TPUT) of network communication data is equal to or smaller than a configured value. For example, when throughput in the on state of the display is equal to or smaller than a first threshold value (e.g., 40 Mbps), the electronic device 101 may identify the state related to the dual connectivity restriction. When throughput in the off state of the display is smaller than a second threshold value (e.g., 10 kbps), the electronic device 101 may identify the state related to the dual connectivity restriction. The first threshold value and the second threshold value may be the same as each other or different from each other. The state information of the electronic device related to the dual connectivity restriction may include a state in which a battery charge is equal to or lower than a configured value (e.g., 15%) or a state in which temperature is higher than a configured value.

State information (e.g., display off state information) of the electronic device 101 related to dual connectivity restriction of the electronic device 101 or event information may be determined on the basis of inter-process communication (IPC) information that can be acquired by a processor (e.g., the processor 120, the first communication processor 212, the second communication processor 214, or the integrated communication processor 260).

The AP 120 of the electronic device 101 may transmit information related to dual connectivity restriction (e.g., event information or state information) to the CP 260 in operation 1306. When the state related to the dual connectivity restriction is identified, the CP 260 of the electronic device 101 may change a configuration related to dual connectivity in operation 1308. For example, the CP 260 of the electronic device 101 may change the configuration related to dual connectivity from a first state (e.g., NR NSA mode+NR SA mode) to a second state (e.g., NR SA only mode). The CP 260 of the electronic device 101 may change the NR NSA mode related to dual connectivity from an enabled state to a disabled state. The operation for changing the mode may include at least one of an operation for changing a state value of at least one flag indicating the state of the electronic device 101 and an operation for executing an instruction of configuring the state of the electronic device 101, but there is no limitation. For example, the change in at least one operation performed by the electronic device 101 may be a mode change for convenience. Alternatively, the mode of the electronic device 101 may be replaced with the state of the electronic device 101. The electronic device 101 may change the NR NSA mode from the enabled state to the disabled state according to the mode change. For example, the electronic device 101 may switch to a state that is the same as an electronic device which does not internally support dual connectivity (e.g., EN-DC) with NR. The electronic device 101 may change and display a list which does not have a mode including NR NSA in the configuration of a user network mode according to the switching or may display a menu for selecting NSA in a deactivated state (for example, gray processing).

The AP 120 of the electronic device 101 may identify the state related to the dual connectivity restriction and change a configuration related to the dual connectivity in operation 1304. For example, the AP 120 of the electronic device 101 may change the configuration related to the dual connectivity from the first state to the second state. The AP 120 of the electronic device 101 may change the NR NSA mode related to dual connectivity from the enabled state to the disabled state. The AP 120 of the electronic device 101 may transmit information on a change in the configuration related to the dual connectivity to the CP 260. The CP 260 may receive information on the configuration related to the dual connectivity from the AP 120 and identify a change in the configuration related to the dual connectivity from the first state to the second state. The CP 260 may identify the change in the configuration related to the dual connectivity from the first state to the second state and store the changed state information in a memory.

The first state may be configured as shown in Table 1, and the second state may be changed as shown in Table 2.

According to various embodiments, the electronic device 101 may transmit information on the configuration related to the dual connectivity to the LTE network 340. For example, the electronic device 101 may change the configuration in Table 1 to the configuration in Table 2 according to identification of the state related to dual connectivity restriction and transmit dual connectivity configuration information including information corresponding to the configuration in Table 2 to the LTE network 340.

The CP 260 of the electronic device 101 may transmit the dual connectivity configuration information to the LTE network 340 through a tracking area update (TAU) request message in operation 1310.

For example, when the first state is configured, the TAU request message may be configured as shown in Table 3 below.

TABLE 3

```
LTE NAS EMM Plain OTA Outgoing Message ---
Tracking area
update request Msg...
Msg_type = 72 (0x48) (Tracking area update request)
Lte_emm_msg
...
  N1Mode = 1 (0x1)
  DCNR = 1 (0x1)
...
  Dual connectivity of E-UTRA with NR
  capability = 1 (0x1)
...
  ue_add_security_cap_inc1 = 1 (0x1)
  ue_add_security_cap
    length = 4 (0x4)
      5G_EA0 = 1 (0x1)
      128_5G_EA1 = 1 (0x1)
      128_5G_EA2 = 1 (0x1)
      128_5G_EA3 = 1 (0x1)
      5G_EA4 = 0 (0x0)
      5G_EA5 = 0 (0x0)
      5G_EA6 = 0 (0x0)
```

Referring to Table 3 above, configuration information corresponding to the first state shown in Table 1 may be included in the TAU request message. When the configuration related to the dual connectivity of the electronic device is changed from the first state to the second state, the TAU request message may be configured as shown in Table 4 below.

TABLE 4

```
LTE NAS EMM Plain OTA Outgoing Message ---
Tracking area
update request Msg...
Msg_type = 72 (0x48) (Tracking area update request)
Lte_emm_msg
...
  N1Mode = 1 (0x1)
  DCNR = 0 (0x0)
...
  Dual connectivity of E-UTRA with NR
  capability = 0 (0x0)
...
  ue_add_security_cap_inc1 = 1 (0x1)
  ue_add_security_cap
    length = 4 (0x4)
      5G_EA0 = 1 (0x1)
      128_5G_EA1 = 1 (0x1)
      128_5G_EA2 = 1 (0x1)
      128_5G_EA3 = 1 (0x1)
      5G_EA4 = 0 (0x0)
      5G_EA5 = 0 (0x0)
      5G_EA6 = 0 (0x0)
```

Referring to Table 4 above, configuration information corresponding to the second state shown in Table 2 may be included in the TAU request message.

The CP 260 of the electronic device 101 may insert the configuration in Table 4 into the TAU request message and transmit the TAU request message in operation 1310 according to the change in the configuration related to the dual connectivity from the first state to the second state in operation 1308.

The LTE network 340 may transmit a UE capability enquiry in operation 1312. The UE capability enquiry transmitted by the LTE network 340 may include information related to the NR SA only mode. For example, the UE capability enquiry may be configured as shown in Table 5 below.

TABLE 5

```
LTE RRC OTA Packet - DL_DCCH /
UECapabilityEnquiry
Subscription ID=1
Pkt Version = 26
RRC Release Number. Major. Minor = 15.5.0
NR RRC Release Number Major minor = 15.9.0
Radio Bearer ID = 1, Physical Call ID = 289
Freq = 1300
SysFramNum = N/A, SubFrameNum = 0
PDU Number = DL_DCCH Message,
Msg Length = 11
SIB Mask in SI = 0x00
Interpreted PDU
Value DL-DCCH-Message ::”
{
  Message c1 : ueCapabilityEnquiry
    {
      rrc-TransactionIdentifier 2,
      criticalExtensions c1 :
      ueCapabilityEnquiry-r8 :
        {
          Ue-CapabilityRequest
          {
            Nr
        }
```

Referring to Table 5 above, the UE capability enquiry is expressed as “nr”, which may indicate that the NR SA only mode is in the enabled state.

When the electronic device 101 changes the configuration related to the dual connectivity from the second state to the first state, the electronic device 101 may transmit the TAU request message in Table 3 to the LTE network 340 as described above. The LTE network 340 may identify the TAU request message, identify the change in the configuration related to the dual connectivity of the electronic device 101 from the second state to the first state, and transmit a UE capability enquiry as shown in Table 6 below to the electronic device 101.

```
LTE RRC OTA Packet - DL_DCCH /
UECapabilityEnquiry
Subscription ID=2
Pkt Version = 26
RRC Release Number. Major. Minor = 15.5.0
NR RRC Release Number Major minor = 15.9.0
Radio Bearer ID = 1, Physical Call ID = 476
Freq = 1825
SysFramNum = N/A, SubFrameNum = 8
PDU Number = DL_DCCH Message,
Msg Length = 12
SIB Mask in SI = 0x00
Interpreted PDU
Value DL-DCCH-Message ::”
{
  Message c1 : ueCapabilityEnquiry
    {
      rrc-TransactionIdentifier 3,
      criticalExtensions c1 :
      ueCapabilityEnquiry-
r8 :
        {
          Ue-CapabilityRequest
          {
            eutra-nr
            nr
```

Referring to Table 6 above, the UE capability enquiry is expressed as “eutra-nr” and “nr”, which may indicate that the NR NSA mode and the NR SA only mode are in the enabled state.

The CP 260 of the electronic device 101 may insert information related to the NR SA mode into the UE capability information and transmit the UE capability information to the LTE network 340 in operation 1314.

The LTE network 340 may identify the dual connectivity configuration information and may transmit a measurement configuration including a B1 event for the NR SA connection to the electronic device 101 in operation 1316 since NR NSA is disabled for the electronic device 101 but NR SA is enabled.

The electronic device may receive the measurement configuration including the B1 event from the LTE network 340 and identify a measurement object corresponding to the B1 event included in the measurement configuration. The CP 260 of the electronic device 101 may measure the identified measurement object in operation 1318 and may transmit a measurement report (MR) to the network 340 in operation 1320.

The electronic device 101 may not perform an NR NSA procedure with the NR (EN-DC) base station 351a by SCG addition in operation 1322 but may perform an NR SA procedure with the NR (SA) base station 351b in operation 1324 by transmitting the measurement for NR SA and the measurement report to the LTE network 340. For example, the electronic device 101 may perform a handover or redirection procedure from the LTE network 340 to the 5G network 350 in operation 1324. Referring to FIG. 13, the NR (EN-DC) base station 351a and the NR (SA) base station 351b may be different base stations or may be the same base stations.

FIG. 14 is a flowchart illustrating an operation in which an electronic device accesses a communication network according to an embodiment of the disclosure.

Referring to FIG. 14, the CP 260 of the electronic device 101 may perform EPS fallback to the LTE network 340 in operation 1402 according to FIG. 8 or FIG. 9 to make a call through the LTE network 340 and return to the 5G network 350 before the fallback according to termination of the call.

When the call is terminated for various reasons in operation 1404, a dedicated bearer between the electronic device 101 and the LTE network 340 (e.g., eNB 341/EPC 342) may be deactivated in operation 1406.

The AP 120 of the electronic device 101 may identify a state related to dual connectivity restriction in operation 1408. The state information of the electronic device related to the dual connectivity restriction may include at least one of an on/off state of a display and a state in which throughput (TPUT) of network communication data is equal to or smaller than a configured value. For example, when throughput in the on state of the display is equal to or smaller than a first threshold value (e.g., 40 Mbps), the electronic device 101 may identify the state related to the dual connectivity restriction. When throughput in the off state of the display is smaller than a second threshold value (e.g., 10 kbps), the electronic device 101 may identify the state related to the dual connectivity restriction. The first threshold value and the second threshold value may be the same as each other or different from each other. The state information of the electronic device related to the dual connectivity restriction may include a state in which a battery charge is equal to or lower than a configured value (e.g., 15%) or a state in which temperature is higher than a configured value.

According to various embodiments, state information (e.g., display off state information) of the electronic device 101 related to dual connectivity restriction of the electronic device 101 or event information may be determined on the basis of inter-process communication (IPC) information that can be acquired by a processor (e.g., the processor 120, the first communication processor 212, the second communication processor 214, or the integrated communication processor 260).

The AP 120 of the electronic device 101 may transmit information related to dual connectivity restriction (e.g., event information or state information) to the CP 260 in operation 1410. According to various embodiments, when the state related to the dual connectivity restriction is identified, the CP 260 of the electronic device 101 may change a configuration related to dual connectivity in operation 1412. For example, the CP 260 of the electronic device 101 may change the configuration related to dual connectivity from a first state (e.g., NR NSA mode+NR SA mode) to a second state (e.g., NR SA only mode). The CP 260 of the electronic device 101 may change the NR NSA mode related to dual connectivity from an enabled state to a disabled state. The operation for changing the mode may include at least one of an operation for changing a state value of at least one flag indicating the state of the electronic device 101 and an operation for executing an instruction of configuring the state of the electronic device 101, but there is no limitation. For example, the change in at least one operation performed by the electronic device 101 may be a mode change for convenience. Alternatively, the mode of the electronic device 101 may be replaced with the state of the electronic device 101. The electronic device 101 may change the NR NSA mode from the enabled state to the disabled state according to the mode change. For example, the electronic device 101 may switch to a state that is the same as an electronic device which does not internally support dual connectivity (for example, EN-DC) with NR. The electronic device 101 may change and display a list which does not have a mode including NR NSA in the configuration of a user network mode according to the switching or may display a menu for selecting NSA in a deactivated state (for example, gray processing).

The AP 120 of the electronic device 101 may identify a state related to dual connectivity restriction and change a configuration related to dual connectivity in operation 1410. For example, the AP 120 of the electronic device 101 may change the configuration related to the dual connectivity from the first state to the second state. The AP 120 of the electronic device 101 may change the NR NSA mode related to dual connectivity from the enabled state to the disabled state. The AP 120 of the electronic device 101 may transmit information on a change in the configuration related to the dual connectivity to the CP 260. The CP 260 may receive information on the configuration related to the dual connectivity from the AP 120 and identify a change in the configuration related to the dual connectivity from the first state to the second state. The CP 260 may identify the change in the configuration related to the dual connectivity from the first state to the second state and store the changed state information in a memory.

The first state may be configured as shown in Table 1, and the second state may be changed as shown in Table 2.

The electronic device 101 may transmit information on the configuration related to the dual connectivity to the LTE network 340 as described above. For example, the electronic device 101 may change the configuration in Table 1 to the configuration in Table 2 according to identification of the state related to dual connectivity restriction and transmit dual connectivity configuration information including information corresponding to the configuration in Table 2 to the LTE network 340.

The CP 260 of the electronic device 101 may transmit the dual connectivity configuration information to the LTE network 340 through a tracking area update (TAU) request message. For example, when the first state (for example, NR NSA mode+NR SA mode) is configured, the TAU request message may be configured as shown in Table 3 described above. According to various embodiments, when the configuration related to the dual connectivity of the electronic device is changed from the first state to the second state, the TAU request message may be configured as shown in Table 4 described above.

The CP 260 of the electronic device 101 may insert the configuration in Table 4 into the TAU request message and transmit the TAU request message in operation 1412 according to the change in the configuration related to the dual connectivity from the first state to the second state in operation 1414.

The LTE network 340 may transmit a UE capability enquiry in operation 1416. The UE capability enquiry transmitted by the LTE network 340 may include information related to the NR SA only mode. For example, the UE capability enquiry may be configured as shown in Table 5 described above.

When the electronic device 101 changes the configuration related to the dual connectivity from the second state to the first state, the electronic device 101 may transmit the TAU request message in [Table 3] to the LTE network 340 as described above. The LTE network 340 may identify the TAU request message, identify the change in the configuration related to the dual connectivity of the electronic device 101 from the second state to the first state, and transmit a UE capability enquiry as shown in Table 6 below to the electronic device 101. The CP 260 of the electronic device 101 may insert information related to the NR SA mode into the UE capability information and transmit the UE capability information to the LTE network 340 in operation 1418.

The LTE network 340 may identify the dual connectivity configuration information and may transmit a measurement configuration including a B1 event for the NR SA connection to the electronic device 101 in operation 1420 since NR NSA is disabled for the electronic device 101 but NR SA is enabled.

The electronic device may receive the measurement configuration including the B1 event from the LTE network 340 and identify a measurement object corresponding to the B1 event included in the measurement configuration. The CP 260 of the electronic device 101 may measure the identified measurement object in operation 1422 and may transmit a measurement report (MR) to the network 340 in operation 1424.

The electronic device 101 may not perform an NR NSA procedure with the NR (EN-DC) base station 351a by SCG addition in operation 1426 but may perform an NR SA procedure with the NR (SA) base station 351b in operation 1428 by transmitting the measurement for NR SA and the measurement report to the LTE network 340. For example, the electronic device 101 may perform a handover or redirection procedure from the LTE network 340 to the 5G network 350 in operation 1428. Referring to FIG. 14, the NR (EN-DC) base station 351a and the NR (SA) base station 351b may be different base stations or may be the same base stations.

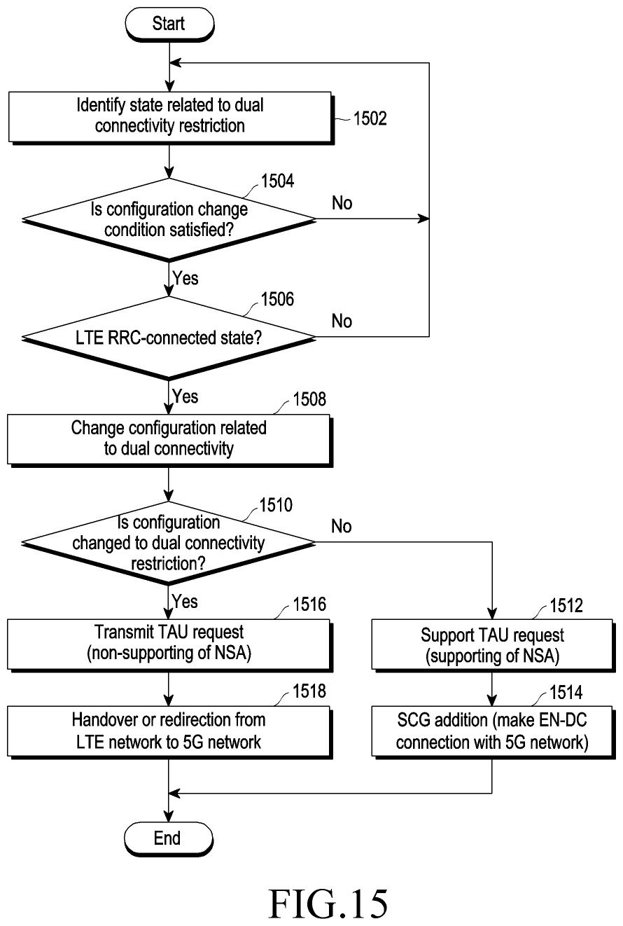

FIG. 15 is a flowchart illustrating a method by which an electronic device controls a connection with a communication network according to an embodiment of the disclosure.

Referring to FIG. 15, the electronic device 101 may identify a state related to dual connectivity restriction in operation 1502. The identification of the state related to the dual connectivity restriction may be performed on every period (e.g., 10 seconds). The electronic device 101 may identify whether the identified state information satisfies a condition for changing the configuration related to the dual connectivity restriction. For example, if the display was in an on state when a previous state was identified but the display is changed to an off state when a current state is identified, the electronic device 101 may determine that a condition for changing the first state to the second state is satisfied. When it is determined that the configuration change condition is not satisfied in operation 1504 (No of operation 1504), the electronic device may return to operation 1502.

When it is determined that the configuration change condition is satisfied on the basis of the identification result (Yes of operation 1504), the electronic device may identify whether the electronic device is in an LTE RRC connection state in operation 1506. When the LTE RRC connection state is identified on the basis of the identification result (Yes of operation 1506), the electronic device 101 may change the configuration related to dual connectivity in operation 1508. When the electronic device is not in the LTE RRC connection state on the basis of the identification result (No of operation 1506), the electronic device 101 may return to operation 1502.

When the configuration change is a configuration change to dual connectivity restriction in operation 1510 (e.g., when the configuration change is a change from a dual connectivity activation mode to a dual connectivity deactivation mode) (Yes of operation 1510), the electronic device 101 may insert non-supporting of NSA into a TAU request message and transmit the TAU request message to the LTE network in operation 1516. The electronic device 101 cannot make an EN-DC connection according to non-supporting of NSA but may perform a handover redirection from the LTE network to the 5G network in operation 1518.

When the configuration change is a configuration change to dual connectivity restriction release in operation 1510 (e.g., when the configuration change is a change from a dual connectivity deactivation mode to a dual connectivity activation mode) (No of operation 1510), the electronic device 101 may insert supporting of NSA into a TAU request message and transmit the TAU request message to the LTE eNB in operation 1512. The electronic device 101 may make the EN-DC connection with the 5G network according to supporting of NSA in operation 1514. The electronic device 101 may also support SA and thus perform the handover or redirection to the 5G network.

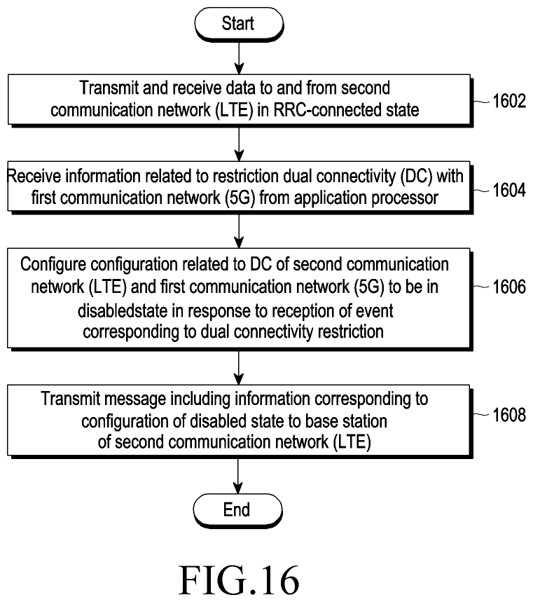

FIG. 16 is a flowchart illustrating a method by which an electronic device controls a connection with a communication network according to an embodiment of the disclosure.

Referring to FIG. 16, the electronic device 101 may transmit and receive data to and from a second communication network (LTE) in an RRC-connected state in operation 1602.

The electronic device 101 may receive information related to restriction of dual connectivity (DC) with a first communication network (5G) from an application processor in operation 1604.

The electronic device 101 may configure a configuration related to dual connectivity (DC) with the second communication network (LTE) and the first communication network (5G) to be in a disabled state in response to reception of an event corresponding to dual connectivity restriction in operation 1606.

The electronic device 101 may transmit a message including information corresponding to the configuration of the disabled state to the base station of the second communication network (LTE) in operation 1608.

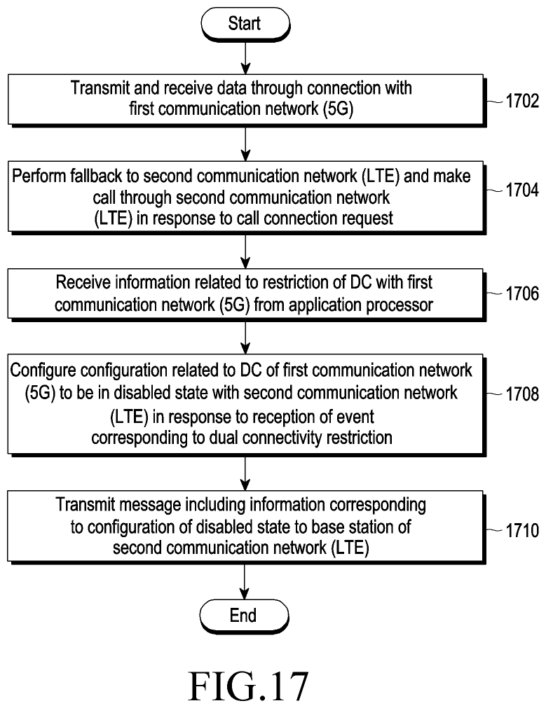

FIG. 17 is a flowchart illustrating a method by which an electronic device controls a connection with a communication network according to an embodiment of the disclosure.

Referring to FIG. 17, the electronic device 101 may be connected to the first communication network (5G) to transmit and receive data in operation 1702. In operation 1704, the electronic device may perform fallback to the second communication network (LTE) in response to a call connection request and perform a call through the second communication network (LTE).

The electronic device 101 may receive information related to restriction of the dual connectivity (DC) with the first communication network (5G) from the application processor in operation 1706.

The electronic device 101 may configure a configuration related to dual connectivity (DC) with the first communication network (5G) to be in a disabled state with the second communication network (LTE) in response to reception of an event corresponding to dual connectivity restriction in operation 1708.

The electronic device 101 may transmit a message including information corresponding to the configuration of the disabled state to the base station of the second communication network (LTE) in operation 1710.

An electronic device according to one of the various embodiments includes an application processor, at least one antenna module, and at least one communication processor configured to receive a communication service from a first communication network and a second communication network through the at least one antenna module, wherein the at least one communication processor is configured to transmit and receive data to and from the second communication processor in an RRC-connected state with the second communication processor, receive information related to restriction of dual connectivity (DC) with the first communication network from the application processor, set a configuration related to the dual connectivity between the first communication network and the second communication network to be in a disabled state in response to reception of the information related to the restriction of the dual connectivity, and control to transmit a message including information corresponding to the configuration to a base station of the second communication network.

The information related to the restriction of the dual connectivity may include state information of the electronic device related to the restriction of the dual connectivity.

The state information of the electronic device related to the restriction of the dual connectivity may include at least one of an on/off state of a display and a state in which throughput of network communication data is equal to or smaller than a set value.

The state information of the electronic device related to the restriction of the dual connectivity may include a state in which a battery charge is equal to or lower than a set value or a state in which temperature is larger than a set value.

The information related to the restriction of the dual connectivity may include information on a change in a configuration of the dual connectivity.

The first communication network may include a 5G communication network, and the second communication network may include an LTE communication network.

The dual connectivity may include an E-UTRA new radio dual connectivity (EN-DC) connection.

The message including the information corresponding to the configuration may include a tracking area update (TAU) request message.

The at least one communication processor may be configured to transmit and receive data through a connection to the first communication network, perform fallback to the second communication network to make a call through the second communication network in response to a call connection request, and receive information related to the restriction of the dual connectivity with the first communication network from the application processor during the call.

The at least one communication processor may be configured to perform a handover or redirection from the first communication network to the second communication network after transmitting the message including the information corresponding to the configuration.

A method of controlling a connection with a communication network connection by an electronic device may include an operation of transmitting and receiving data to and from a second communication processor in an RRC-connected state with the second communication processor, an operation of receiving information related to restriction of dual connectivity (DC) with a first communication network from an application processor, an operation of setting a configuration related to the dual connectivity between the first communication network and the second communication network to be in a disabled state in response to reception of the information related to the restriction of the dual connectivity, and an operation of transmitting a message including information corresponding to the configuration to a base station of the second communication network.

The method may further include an operation of transmitting and receiving data through a connection with the first communication network, an operation of performing fallback to the second communication network to make a call through the second communication network in response to a call connection request, and an operation of receiving information related to the restriction of the dual connectivity with the first communication network from the application processor during the call.

The method may further include an operation of performing a handover or redirection from the first communication network to the second communication network after transmitting the message including the information corresponding to the configuration.

The electronic device according to various embodiments may be one of various types of electronic devices. The electronic devices may include, for example, a computer device, a portable communication device (e.g., a smartphone), a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., a master device or a task performing device). For example, a processor of the machine (e.g., the master device or the task performing device) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
an application processor;
at least one antenna module; and
at least one communication processor configured to receive a communication service from a first communication network and a second communication network through the at least one antenna module,
wherein the at least one communication processor is configured to:
transmit and receive data to and from a second communication processor in an radio resource control (RRC)-connected state with the second communication processor,
receive information related to restriction of dual connectivity (DC) with the first communication network from the application processor,
in response to reception of the information related to the restriction of the dual connectivity, set a configuration related to the dual connectivity between the first communication network and the second communication network to be in a disabled state, and
control to transmit a message including information corresponding to the configuration to a base station of the second communication network.

2. The electronic device of claim 1, wherein the information related to the restriction of the dual connectivity includes state information of the electronic device related to the restriction of the dual connectivity.

3. The electronic device of claim 2, wherein the state information of the electronic device related to the restriction of the dual connectivity includes at least one of an on/off state of a display and a state in which throughput of network communication data is equal to or smaller than a configured value.

4. The electronic device of claim 2, wherein the state information of the electronic device related to the restriction of the dual connectivity includes a state in which a battery charge is equal to or lower than a first set value or a state in which temperature is larger than a second set value.

5. The electronic device of claim 1, wherein the information related to the restriction of the dual connectivity includes information on a change in a configuration of the dual connectivity.

6. The electronic device of claim 1,
wherein the first communication network includes a fifth generation (5G) communication network, and
wherein the second communication network includes an long term evolution (LTE) communication network.

7. The electronic device of claim 6, wherein the dual connectivity includes an evolved-universal terrestrial radio access (E-UTRA) new radio dual connectivity (EN-DC) connection.

8. The electronic device of claim 1, wherein the message including the information corresponding to the configuration includes a tracking area update (TAU) request message.

9. The electronic device of claim 1, wherein the at least one communication processor is further configured to:
transmit and receive data through a connection to the first communication network;
in response to a call connection request, perform fallback to the second communication network to make a call through the second communication network; and
receive information related to the restriction of the dual connectivity with the first communication network from the application processor during the call.

10. The electronic device of claim 1, wherein the at least one communication processor is further configured to perform a handover or redirection from the first communication network to the second communication network after transmitting the message including the information corresponding to the configuration.

11. A method of controlling a connection with a communication network connection by an electronic device, the method comprising:
transmitting and receiving data to and from a second communication processor in a radio resource control (RRC)-connected state with the second communication processor;
receiving information related to restriction of dual connectivity (DC) with a first communication network from an application processor;
in response to reception of the information related to the restriction of the dual connectivity, setting a configuration related to the dual connectivity between the first communication network and the second communication network to be in a disabled state; and
transmitting a message including information corresponding to the configuration to a base station of the second communication network.

12. The method of claim 11, wherein the information related to the restriction of the dual connectivity includes state information of the electronic device related to the restriction of the dual connectivity, and
wherein the state information of the electronic device related to the restriction of the dual connectivity includes at least one of an on/off state of a display and a state in which throughput of network communication data is equal to or smaller than a configured value.

13. The method of claim 11, wherein the information related to the restriction of the dual connectivity includes state information of the electronic device related to the restriction of the dual connectivity, and
wherein the state information of the electronic device related to the restriction of the dual connectivity includes a state in which a battery charge is equal to or lower than a first set value or a state in which temperature is larger than a second set value.

14. The method of claim 11,
wherein the first communication network includes a fifth generation (5G) communication network,
wherein the second communication network includes an long term evolution (LTE) communication network, and
wherein the dual connectivity includes an evolved-universal terrestrial radio access (E-UTRA) new radio dual connectivity (EN-DC) connection.

15. The method of claim 11, further comprising:
transmitting and receiving data through a connection with the first communication network;
in response to a call connection request, performing fallback to the second communication network to make a call through the second communication network; and
receiving information related to the restriction of the dual connectivity with the first communication network from the application processor during the call.

16. The method of claim 11, further comprising performing a handover or redirection from the first communication network to the second communication network after transmitting the message including the information corresponding to the configuration.

17. The method of claim 12, wherein the state information of electronic device relates to at least one of a throughput of the electronic device being less than or equal to a first threshold value while the display is in an on state or the throughput of the electronic device being less than or equal to a second threshold value while the display is in an off state.

18. The method of claim 17, wherein the first threshold value is the same as the second threshold value.

19. The method of claim 11, wherein the setting of the configuration information comprises setting the configuration to one or a first state or a second state.

20. The method of claim 19,
wherein the first state is a new radio (NR) non-standalone (NSA) mode plus NR standalone (SA) mode, and
wherein the second state is an NR SA only mode.
